(19) United States
(12) Patent Application Publication
(10) Pub. No.: US 2026/0357993 A1
(43) Pub. Date: Nov. 12, 2026

(54) COOKING APPLIANCE

(71) Applicant: SAMSUNG ELECTRONICS CO., LTD., Suwon-si (KR)

(72) Inventors: Sooncheol KWEON, Suwon-si (KR); Sangbeom KIM, Suwon-si (KR); Sangbum KIM, Suwon-si (KR); Bokhyun JANG, Suwon-si (KR)

(73) Assignee: SAMSUNG ELECTRONICS CO., LTD., Suwon-si (KR)

(21) Appl. No.: 19/717,494

(22) Filed: Jun. 23, 2026

Related U.S. Application Data
(63) Continuation of application No. PCT/KR2024/016771, filed on Oct. 30, 2024.

(30) Foreign Application Priority Data
Dec. 29, 2023 (KR) 10-2023-0197767

(51) Int. Cl. F24C 15/02; E05B 47/00

(52) U.S. Cl. CPC F24C 15/022; E05B 47/0012; E05B 2047/0017; E05B 2047/0024

(57) ABSTRACT

A cooking apparatus including a main body forming a cooking chamber, a door including a door locking part, a latch disposed in the main body to be movable between a first latch position of being caught on the door locking part and a second latch position of being separated from the door locking part, a slider connectable to the latch to be movable between a first slider position while the latch is located at the first latch position and a second slider position while the latch is located at the second latch position, and a locker disposed in the main body to be movable between a locking position of restricting the slider from moving from the first slider position to the second slider position and an unlocking position of allowing the slider to move between the first slider position and the second slider position.

### CROSS-REFERENCE TO RELATED APPLICATION

This application is a continuation application, under 35 U.S.C. § 111(a), of international application No. PCT/KR2024/016771, filed Oct. 30, 2024, which claims priority under 35 U.S.C. § 119 to Korean Patent Application No. 10-2023-0197767, filed Dec. 29, 2023, the disclosures of which are incorporated herein by reference in their entireties.

### TECHNICAL FIELD

The present disclosure relates to a cooking apparatus.

### BACKGROUND ART

Cooking apparatuses are apparatuses for cooking by heating a cooking object such as food, and refer to apparatuses capable of providing various functions related to cooking, such as heating, thawing, drying, and sterilization of a cooking object. Cooking apparatuses include, for example, an oven such as a gas oven and an electric oven, a microwave heating device (hereinafter referred to as a microwave oven), a gas range, an electric range, a hood combined microwave oven (Over the Range; OTR), a gas grill or an electric grill, and the like.

Ovens are apparatuses that cook food by directly transferring heat to the food through a heating source such as a heater or by heating the inside of a cooking chamber. Microwave ovens are apparatuses that cook food by frictional heat generated between molecules by disturbing a molecular arrangement of the food using high frequency as a heating source.

A cooking apparatus includes a cooking chamber for cooking food and a door for opening and closing the cooking chamber. Because the cooking apparatus needs to be operated in a state in which the cooking chamber is closed, the cooking apparatus is provided with a latch device to secure the door in the closed state. A latch of the latch device rotates on a main body to support or release the door.

### DISCLOSURE

### Technical Problem

The present disclosure is directed to providing a cooking apparatus having an improved structure such that a door may be opened automatically.

The present disclosure is directed to providing a cooking apparatus having an improved structure such that a door may be opened manually even when a driving module of a latch device does not operate.

The present disclosure is directed to providing a cooking apparatus having an improved structure such that a door may be firmly locked.

The present disclosure is directed to providing a cooking apparatus having an improved structure such that a space occupied by a driving module and a locking module of a latch device inside a main body may be saved and assembly processes of components may be performed efficiently.

Technical tasks to be achieved in the present disclosure are not limited to the technical tasks mentioned above, and other technical tasks not mentioned will be clearly understood by those skilled in the art from the description below.

### Technical Solution

A cooking apparatus according to an embodiment of the present disclosure may include: a main body forming a cooking chamber; a door, configured to open and close the cooking chamber, including a door locking part; a latch to be disposed in the main body such that while the latch is in the main body, the latch is movable between a first latch position of being caught on the door locking part and a second latch position of being separated from the door locking part; a slider connectable to the latch such that while the slider connected to the latch, the slider is to be movable between a first slider position while the latch is located at the first latch position and a second slider position while the latch is located at the second latch position; and a locker to be disposed in the main body such that while the locker is in the main body, the locker is movable between a locking position of restricting the slider from moving from the first slider position to the second slider position and an unlocking position of allowing the slider to move between the first slider position and the second slider position.

A cooking apparatus according to an embodiment of the present disclosure may include: a main body forming a cooking chamber; a door, configured to open and close the cooking chamber, including a door locking part; a latch to be disposed in the main body such that while the latch is in the main body, the latch is rotatable with respect to the main body to be caught on the door locking part or separated from the door locking part; a slider, to be disposed in the main body, connectable to the latch such that while the slider connected to the latch, the slider is movable with respect to the main body in conjunction with the rotation of the latch; and a locker to be disposed in the main body such that while the locker is in the main body, the locker is movable between a locking position of fixing the slider and an unlocking position of being spaced apart from the slider to allow the slider to move with respect to the main body.

A cooking apparatus according to an embodiment of the present disclosure may include: a main body forming a cooking chamber; a door configured to open and close the cooking chamber; a latch mountable in the main body such that while the latch is mounted in the main body, the latch is movable between a first latch position of supporting the door and a second latch position of releasing the support of the door to enable the door to be opened; a driving source to disposed in the main body to generate a driving force; and a locker to be disposed in the main body to receive the driving force from the driving source to be movable between a locking position of restricting the latch from moving from the first latch position to the second latch position and an unlocking position of allowing the latch to move between the first latch position and the second latch position.

### DESCRIPTION OF DRAWINGS

FIG. 1 is a perspective view of a cooking apparatus according to an embodiment of the present disclosure.

FIG. 2 is a front view of the cooking apparatus with an opened door according to an embodiment of the present disclosure.

FIG. 3 is a view illustrating a latch device of the cooking apparatus according to an embodiment of the present disclosure.

FIG. 4 is a view illustrating a latch and a portion of the door mounted in a main body of the cooking apparatus according to an embodiment of the present disclosure.

FIG. 5 is a top view illustrating a portion of the main body of the cooking apparatus and the latch mounted therein according to an embodiment of the present disclosure.

FIG. 6 is a view illustrating a driving module and a locking module of the latch device of the cooking apparatus according to an embodiment of the present disclosure.

FIG. 7 is an exploded view of the driving module and the locking module of the latch device of the cooking apparatus according to an embodiment of the present disclosure.

FIG. 8 is a top view of components of the driving module, such as a slider, a connecting rod, and a pusher, of the latch device of the cooking apparatus according to an embodiment of the present disclosure.

FIG. 9 is a bottom view of components of the locking module, such as a locker and a cam, of the latch device of the cooking apparatus according to an embodiment of the present disclosure.

FIG. 10 is a view illustrating an appearance of the latch device when the door of the cooking apparatus is closed according to an embodiment of the present disclosure.

FIG. 11 is a view illustrating the latch device that operates to open the door when a locker of the latch device of the cooking apparatus is located at an unlocking position according to an embodiment of the present disclosure.

FIG. 12 is a view illustrating the latch device when the door is forcibly opened in a state where the driving module is not operating and when the locker of the latch device of the cooking apparatus is located at the unlocking position according to an embodiment of the present disclosure.

FIG. 13 is a view illustrating a state in which the locker of the latch device of the cooking apparatus is located at the unlocking position according to an embodiment of the present disclosure.

FIG. 14 is a view illustrating a state in which the locker of the latch device of the cooking apparatus is located at a locking position according to an embodiment of the present disclosure.

FIG. 15 is a view illustrating the state in which the locker of the latch device of the cooking apparatus is located at the locking position according to an embodiment of the present disclosure.

### MODE OF THE DISCLOSURE

The embodiments described in the present disclosure and the configurations shown in the drawings are only examples of preferred embodiments of the present disclosure, and various modifications may be made at the time of filing of the present disclosure to replace the embodiments and drawings of the present specification.

Like reference numbers or signs in the various drawings of the present disclosure represent parts or components that perform substantially the same functions.

The terms used herein are for the purpose of describing the embodiments and are not intended to restrict and/or to limit the present disclosure. For example, the singular expressions herein may include plural expressions, unless the context clearly dictates otherwise. Also, the terms “comprises” and “has” are intended to indicate that there are features, numbers, steps, operations, components, parts, or combinations thereof described in the specification, and do not exclude the presence or addition of one or more other features, numbers, steps, operations, components, parts, or combinations thereof.

It will be understood that, although terms including ordinal numbers, such as “first,” “second,” etc., used in this specification may be used to describe various components, these components should not be limited by these terms, and the terms are only used to distinguish one from another component. For example, a first component may be referred to as a second component without departing from the scope of the present disclosure, and similarly, the second component may also be referred to as the first component. The term “and/or” includes any combination of a plurality of related items or any one of a plurality of related items.

In this specification, when it is described that a part is “connected” to another part, this includes not only a case where it is directly connected, but also a case where it is indirectly connected.

The terms “upper,” “lower,” “front,” “rear,” “left,” “right,” etc., used in the description below are defined with respect to the drawings, and the shape and position of each component are not limited by these terms. For example, the terms “upper” and “lower” below may each be defined with respect to a Z direction shown in the drawings. The terms “front” and “rear” below may each be defined with respect to an X direction shown in the drawings. The terms “left” and “right” below may each be defined with respect to a Y direction shown in the drawings.

Hereinafter, embodiments according to the present disclosure will be described in detail with reference to the accompanying drawings.

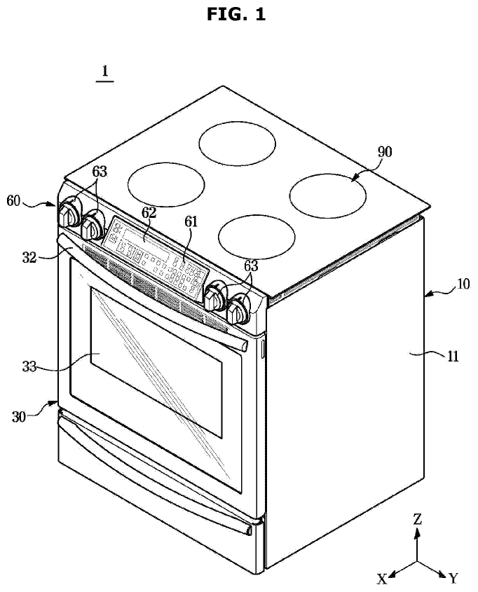

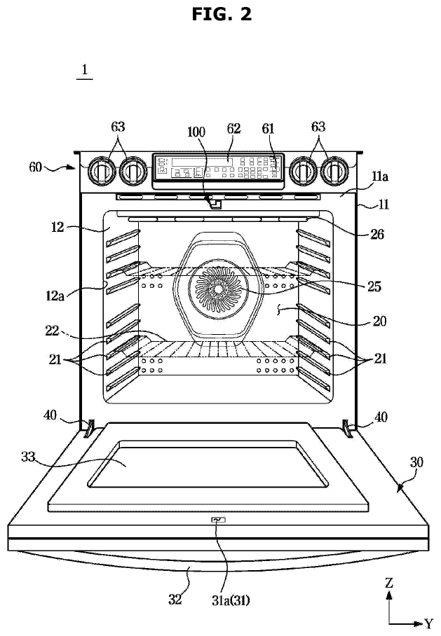

FIG. 1 is a perspective view of a cooking apparatus according to an embodiment of the present disclosure. FIG. 2 is a front view of the cooking apparatus with an opened door according to an embodiment of the present disclosure.

Referring to FIGS. 1 and 2, a cooking apparatus 1 according to an embodiment of the present disclosure may include a cooking chamber 20, a main body 10 forming the cooking chamber 20, and a door 30 provided to open and close the cooking chamber 20.

The main body 10 may include an inner case 12 in which the cooking chamber 20 is formed. The inner case 12 may be provided inside an outer case 11 of the main body 10, which will be described later. In detail, the inner case 12 may be disposed inside the outer case 11 and may be coupled to the outer case 11.

The cooking chamber 20 may be formed with an open front so that food may be taken in and out. The inner case 12 may include a front opening 12a formed to be open to allow food to be taken in and out of the cooking chamber 20. One side of the main body 10 on which the front opening 12a is formed is defined as a front side of the main body 10.

As an example, the inner case 12 may be formed to have a substantially open box shape on the front side.

Inner walls of the inner case 12 may be coated to prevent the inner walls of the inner case 12 from being corroded by condensation water that may occur in a process of condensing water vapor or moisture contained in food itself. The inner walls of the inner case 12 may be dried by heat generated in a food cooking process.

Inside the cooking chamber 20, a tray 22 on which food or a container containing food may be seated, and a rack 21 supporting the tray 22 may be provided. As an example, the tray 22 may be provided to be detachable from the rack 21. As an example, the rack 21 may be provided on the left inner wall or the right inner wall of the inner case 12.

The cooking apparatus 1 may include a heater 26 configured to provide heat to the inside of the cooking chamber 20. As an example, the heater 26 may include a gas burner provided to generate heat by burning gaseous fuel. However, the type of heater included in the cooking apparatus 1 for heating food inside the cooking chamber 20 is not limited thereto, and the cooking apparatus 1 may include a magnetron (not shown) to emit electromagnetic waves into the cooking chamber 20 to generate heat by rotation of water molecules inside food.

The cooking apparatus 1 may include a convection fan 25 configured to circulate air inside the cooking chamber 20. The convection fan 25 may circulate air inside the cooking chamber 20 by rotating with a rotational force provided by a fan motor. As the air inside the cooking chamber 20 is circulated by the convection fan 25, heat generated by the heater 26 may be evenly transferred inside the cooking chamber 20. As an example, the convection fan 25 may be disposed on a rear surface of the cooking chamber 20, but the position thereof is not limited thereto.

The cooking apparatus 1 may include the outer case 11. Various components of the cooking apparatus 1 may be accommodated inside the outer case 11. The outer case 11 may form an outer appearance of the cooking apparatus 1. The outer case 11 may be disposed to surround an upper surface, lower surface, rear surface, left surface, right surface, etc., of the inner case 12 from the outside.

An insulator (not shown) may be provided between the inner case 12 and the outer case 11 to prevent heat inside the cooking chamber 20 from being released to the outside of the main body 10. As an example, the insulator may include a material such as fiberglass or asbestos.

The outer case 11 may include a front frame 11a. The front frame 11a may be provided on a front portion of the main body 10. The front frame 11a may form at least a portion of the front side of the main body 10. When the door 30 closes the cooking chamber 20, the front frame 11a may be covered by the door 30.

The front frame 11a may be formed in the shape of a frame having a substantially opening. The front frame 11a may be formed in the shape of a frame surrounding the front opening 12a.

As an example, the inner case 12 may be coupled to the front frame 11a. A portion of a front side of the inner case 12 may be coupled to the front frame 11a.

In an embodiment, a latch hole 11h, which will be described later, may be formed on the front frame 11a.

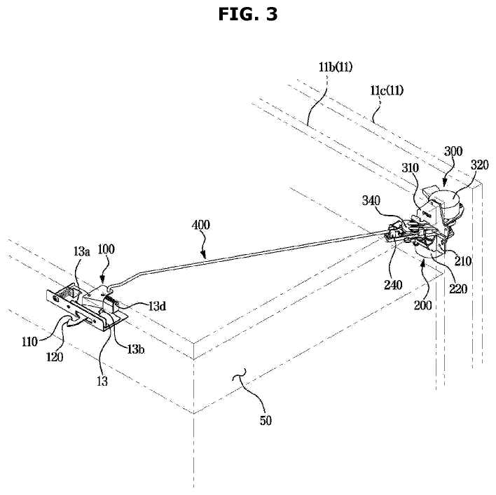

The outer case 11 may include a rear panel 11b (see FIG. 3) disposed on a rear portion of the cooking apparatus 1. The rear panel 11b may form at least a portion of an outer appearance of a rear surface of the cooking apparatus 1. Various components including a gas supply pipe, a printed circuit board for control, the convection fan 25 to be described later, a driving module 200, and a locking module 300 may be mounted on the rear panel 11b.

The outer case 11 may include a rear cover 11c (see FIG. 3) covering at least a portion of the rear panel 11b. The rear cover 11c may cover at least a portion of the rear panel 11b from the rear. The rear cover 11c may form at least a portion of the outer appearance of the rear surface of the cooking apparatus 1. The rear cover 11c may be coupled to the rear of the rear panel 11b.

The rear cover 11c may cover various components such as the gas supply pipe, printed circuit board, convection fan 25, driving module 200, and locking module 300 mounted on the rear panel 11b to protect various components from external impact.

In addition, the outer case 11 may include a left panel forming a left side of the cooking apparatus 1, a right panel forming a right side of the cooking apparatus 1, a base forming a bottom of the cooking apparatus 1, etc.

The cooking apparatus 1 may include an electrical room 50 (see FIG. 3) provided inside the main body 10 so that various electrical components are disposed therein. The electrical room 50 may be formed to be partitioned from the cooking chamber 20. The electrical room 50 may be formed on an inner side of the outer case 11. The electrical room 50 may be formed on an outer side of the inner case 12. For example, the electrical room 50 may accommodate components such as a printed circuit board on which electronic components for controlling operations of various components of the cooking apparatus 1 are mounted, a cooling fan module, and a lever device which will be described later. As an example, the electrical room 50 may be provided on an upper portion of the main body 10.

The cooking apparatus 1 may include a user interface 60. The user interface 60 may be configured to obtain user input or output information about the cooking apparatus 1, such as a cooking mode. For example, the user interface 60 may include an input button 61 provided to obtain a user input. For example, the user interface 60 may include a display 62 configured to display operating information of the cooking apparatus 1. For example, the user interface 60 may include a knob 63.

As an example, the user interface 60 may be mounted in the main body 10. In detail, the user interface 60 may be mounted on the upper portion of the main body 10. The user interface 60 may be mounted on the front portion of the main body 10. However, the position of the user interface 60 is not limited thereto, and the user interface 60 may be disposed in various positions of the cooking apparatus 1, such as an upper portion of the door 30.

The cooking apparatus 1 may include a cooktop 90 configured to seat a cooking container containing food thereon and heat the seated cooking container. In detail, the cooktop 90 may be mounted on the upper portion of the main body 10. The cooktop 90 may form an upper surface of the cooking apparatus 1. As an example, as illustrated in FIG. 1, the cooktop 90 may include an induction cooktop configured to have a coil provided therein and heat the cooking container by induced electromagnetic fields by passing a high frequency current through the coil. Unlike this, as an example, the cooktop 50 may include a gas burner cooktop for generating heat by burning gaseous fuel.

The door 30 of the cooking apparatus 1 may be configured to be rotatable with respect to the main body 10 to open and close the cooking chamber 20. As an example, the door 30 may be rotatably coupled to a lower portion of the main body 10. The door 30 may be configured to be rotatable around a rotation axis positioned at the lower portion of the main body 10. As illustrated in FIGS. 1 and 2, the rotation axis of the door 30 may extend in a horizontal direction Y.

The door 30 may include a handle 32 provided to be gripped by a user to open and close the door 30. To enable the user to easily open and close the door 30, the handle 32 may be positioned adjacent to a portion of the door 30 opposite to the rotation axis of the door 30. FIG. 1 illustrates an embodiment in which the handle 32 is provided on a front surface of the door 30, but the present disclosure is not limited thereto and the handle 32 may be provided at various positions on the door 30. Herein, the ‘front surface of door 30’ refers to one surface of door 30 facing forward in an X direction when the door 30 closes the cooking chamber 20.

The door 30 may include a transparent part 33 formed transparently such that the user may see the inside of the cooking chamber 20 even when the door 30 closes the cooking chamber 20. The transparent part 33 may include various transparent materials such as glass. As an example, the transparent part 33 may be configured to include a plurality of glass plates disposed to be spaced apart from each other and forming an insulating space therebetween to prevent heat inside the cooking chamber 20 from being transferred to the outside of the door 30 through the transparent part 33.

The cooking apparatus 1 may include a hinge 40 configured to connect the main body 10 and the door 30. The hinge 40 may support the door 30 to be rotatable. The hinge 40 may be coupled to each of the main body 10 and the door 30. The door 30 may be coupled to the main body 10 by the hinge 40.

As an example, the hinge 40 may be mounted on the lower portion of the main body 10.

As an example, the hinge 40 may include a pair of the hinges 40.

The cooking apparatus 1 described above with reference to FIGS. 1 and 2 is only an example of the cooking apparatus according to the present disclosure, and the present disclosure is not limited thereto and the cooking apparatus may include various configurations.

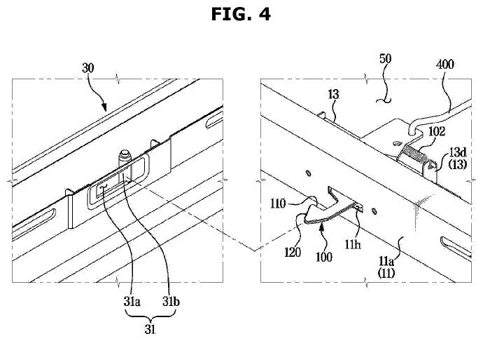

FIG. 3 is a view illustrating a latch device of the cooking apparatus according to an embodiment of the present disclosure. FIG. 4 is a view illustrating a latch and a portion of the door mounted in a main body of the cooking apparatus according to an embodiment of the present disclosure.

Referring to FIGS. 3 and 4, the cooking apparatus 1 according to an embodiment of the present disclosure may include a latch device. The latch device may be configured to secure the closed door 30 or to automatically open the door 30. The latch device may be configured to support the door 30 in a closed position or to release the support of the door 30 and allow the door 30 to be opened.

In detail, the latch device of the cooking apparatus 1 may include a latch 100 and the driving module 200 configured to drive the latch 100.

The latch 100 may be disposed in the main body 10. In detail, the latch 100 may be disposed on the front portion of the main body 10. The latch 100 may be disposed adjacent to the position of the door 30 when the door 30 closes the cooking chamber 20. The latch 100 may be disposed on the upper portion of the main body 10.

One portion of the latch 100 may be disposed inside the main body 10. The other portion of the latch 100 may be disposed outside the main body 10. The one portion of the latch 100 may be installed in the electrical room 50, and the other portion of the latch 100 may protrude to the outside of the electrical room 50.

As an example, the latch 100 may penetrate the front portion of the main body 10. That is, the other portion of the latch 100 may protrude to the outside of the main body 50 by penetrating the front frame 11a. The front frame 11a may include a latch hole 11h formed to be penetrated by the latch 100. The latch hole 11h may be formed to connect the inside and the outside of the main body 10. The latch hole 11h may be formed in a shape in which the front frame 11a is penetrated in the front-rear direction X. When the door 30 closes the cooking chamber 20, the latch hole 11h may face the door 30. In other words, when the door 30 closes the cooking chamber 20, the latch hole 11h may be covered by the door 30.

As an example, the latch hole 11h may be formed on an upper portion of the front frame 11a.

The latch 100 may be mounted in the main body 10. The latch 100 may be supported by the main body 10. The main body 10 may include a latch bracket 13 provided to support the latch 100. The latch bracket 13 may be fixed to the main body 10.

The latch bracket 13 may be provided on the front portion of the main body 10. The latch bracket 13 may be disposed within the electrical room 50. The latch bracket 13 may be disposed adjacent to the front frame 11a. The latch bracket 13 may be disposed adjacent to the latch hole 11h. As an example, the latch bracket 13 may be disposed at the rear of the latch hole 11h and may be disposed at a height substantially corresponding to the latch hole 11h.

As an example, the latch 100 may penetrate the latch bracket 13 and the latch hole 11h, respectively.

A detailed structure of the latch bracket 13 will be described later.

The latch 100 may be provided to be movable with respect to the main body 10. The latch 100 may be provided to be movable relative to the latch bracket 13. The latch bracket 13 may movably support the latch 100.

The latch 100 may be provided to support the door 30 or not support the door 30. In detail, when the cooking chamber 20 is closed by the door 30, the latch 100 may support the door 30 to prevent the door 30 from being opened or may release the support of the door 30 to allow the door 30 to be opened. The expression “the latch 100 releases the support of the door 30” refers to a state in which the latch 100 is separated from the door 30 and does not support the door 30 that is closing the cooking chamber 20.

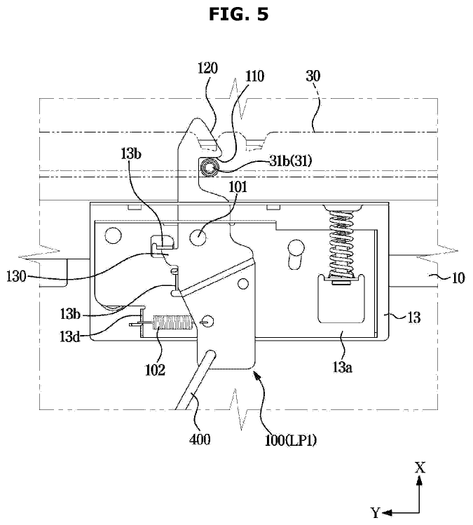

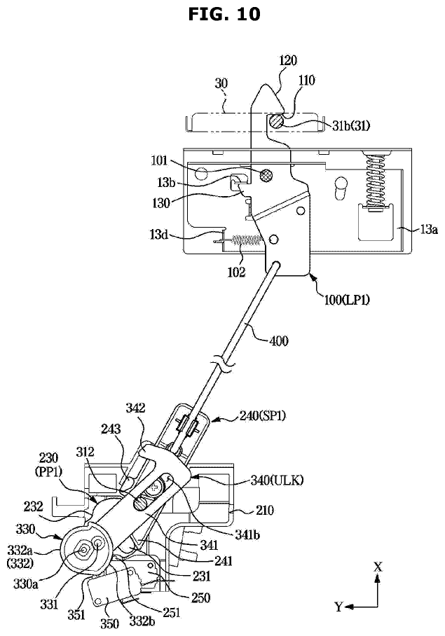

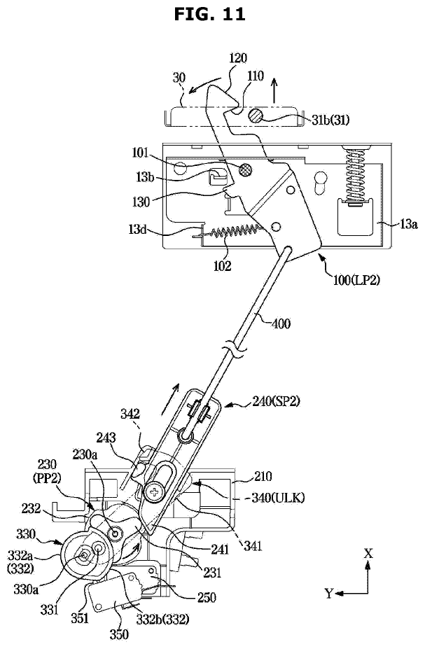

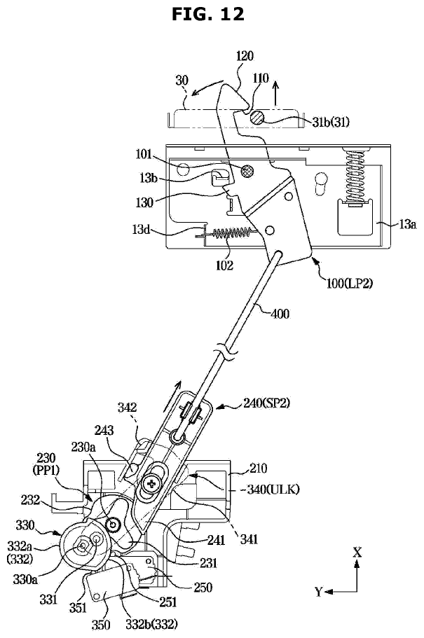

Hereinafter, a position of the latch 100 at which the latch 100 supports the door 30 while the cooking chamber 20 is closed will be referred to as a first latch position LP1 (see FIG. 5, FIG. 10, etc.). Hereinafter, a position at which the latch 100 releases the support of the door 30 while the cooking chamber 20 is closed will be referred to as a second latch position LP2 (see FIGS. 11, 12, etc.). When the door 30 closes the cooking chamber 20, the latch 100 located at the first latch position LP1 may support the door 30 by being caught on the door 30. When the door 30 closes the cooking chamber 20, the latch 100 may release the support of the door 30 by being separated from the door 30 while moving from the first latch position LP1 to the second latch position LP2, and the door 30 may be opened.

The latch 100 may be provided to be movable between the first latch position LP1 and the second latch position LP2.

The door 30 may include a door locking part 31. The door locking part 31 may be configured such that the latch 100 is caught thereon when the door 30 closes the cooking chamber 20 and the latch 100 is located at the first latch position LP1. In other words, when the cooking chamber 20 is closed and the latch 100 is located at the first latch position LP1, the latch 100 may be caught on the door locking part 31. When the latch 100 is caught on the door locking part 31, the door 30 may be secured in a position of closing the cooking chamber 20 by being supported by the latch 100.

When the latch 100 moves from the first latch position LP1 to the second latch position LP2, the latch 100 may be separated from the door locking part 31. When the latch 100 is separated from the door locking part 31, the latch 100 may release the support of the door 30, and the door 30 may be opened.

The door locking part 31 may include, for example, a door hole 31a formed such that a portion of the latch 100 may be inserted thereinto, and a lock pin 31b formed such that the latch 100 may be caught thereon. In detail, when the door 30 closes the cooking chamber 20, a portion of the latch 100 may be inserted into an inside space of the door 30 through the door hole 31a. The portion of the latch 100 inserted into the inside space of the door 30 may be caught on the lock pin 31b when the latch 100 is located at the first latch position LP1 and may support the lock pin 31b. When the latch 100 moves from the first latch position LP1 to the second latch position LP2, the latch 100 may be spaced apart from the lock pin 31b, and when the door 30 rotates in an opening direction, the latch 100 may deviate from the door hole 31a.

The door hole 31a may be formed on an inner surface of the door 30, and the lock pin 31b may be disposed in the inside space of the door 30. Herein, the ‘inner surface of the door 30’ refers to one surface of the door 30 facing the main body 10 when the door 30 closes the cooking chamber 20. As an example, the door hole 31a may be provided on an upper portion of the inner surface of the door 30 to correspond to the latch hole 11h provided on the main body 10.

As an example, as illustrated in FIG. 4, the lock pin 31b may be formed to have a substantially cylindrical shape, but the lock pin 31b is not limited thereto and may have various shapes.

Unlike what is illustrated in FIG. 4, the door locking part 31 may have various structures. For example, the door locking part 31 may include a catch structure formed on an edge side of the door hole 31a, and the latch 100 may be provided to be caught on the catch structure and support the door 30.

In the above, an embodiment has been described in which a portion of the latch 100 protrudes to the outside of the main body 10 and the door locking part 31, particularly the lock pin 31b, is provided inside the door 30, but unlike this, the door locking part 31 may be formed to protrude from the inner surface of the door 30 toward the main body 10, and in this case, the latch 100 may be almost entirely disposed inside the main body 10.

A detailed description of a structure and operation of the latch 100 will be provided later.

The driving module 200 may be configured to move the latch 100 with respect to the main body 10. In detail, the driving module 200 may be configured to move the latch 100 from the first latch position LP1 to the second latch position LP2. Alternatively, the driving module 200 may be configured to move the latch 100 from the second latch position LP2 to the first latch position LP1.

The driving module 200 may be disposed in the main body 10. In detail, the driving module 200 may be disposed on a rear portion of the main body 10. As an example, the driving module 200 may be mounted on the rear panel 11b of the main body 10. As such, when the driving module 200 is disposed on the rear portion of the main body 10, a worker who intends to perform work such as repair, inspection, or parts replacement on the driving module 200 may easily access the driving module 200 by separating the rear cover 11c from the main body 10, thereby improving the convenience of the work.

The position of the driving module 200 is not limited thereto, and the driving module 200 may be disposed at various positions within the main body 10. For example, the driving module 200 may be disposed on the front portion of the main body 10.

The driving module 200 may be disposed on the upper portion of the main body 10. At least a portion of the driving module 200 may be portion in the electrical room 50.

The driving module 200 may be fixed with respect to the main body 10. As an example, the driving module 200 may be fixed to the rear panel 11b of the main body 10. As an example, the driving module 200 may be fastened to the rear panel 11b by screws. However, the driving module 200 is not limited thereto, and may be coupled to various components in the main body 10 and fixed to the main body 10 in various ways.

As an example, the driving module 200 may include a driving module bracket 210 provided to be mounted in the main body 10. As an example, the driving module bracket 210 may be coupled to the rear panel 11b and fixed with respect to the main body 10.

A detailed description of a structure and operation of the driving module 200 will be provided later.

The latch device of the cooking apparatus 1 may further include a connecting rod 400. The connecting rod 400 may connect the latch 100 and the driving module 200. In detail, the connecting rod 400 may connect the latch 100 and a slider 240 of the driving module 200, which will be described later. The slider 240 and the latch 100 may move in conjunction with each other by being connected by the connecting rod 400. The connecting rod 400 may transmit a driving force generated from the driving module 200 to the latch 100.

As an example, the connecting rod 400 may be formed in the shape of a long bar extending substantially in one direction. However, the connecting rod 400 is not limited thereto and may have various shapes of connecting the latch 100 and the driving module 200, specifically the slider 240.

As an example, the latch 100 and the driving module 200 may be arranged substantially parallel to each other in a horizontal direction. In this case, the connecting rod 400 may extend substantially parallel to the horizontal direction between the latch 100 and the driving module 200.

The locking module 300 may be configured to restrict the latch 100 from moving from the first latch position LP1 to the second latch position LP2 or to allow the latch 100 to move from the first latch position LP1 to the second latch position LP2. For example, the locking module 300 may be configured to restrict or allow the movement of the slider 240 of the driving module 200.

The locking module 300 may be disposed in the main body 10. In detail, the locking module 300 may be disposed on the rear portion of the main body 10. As an example, the locking module 300 may be mounted on the rear panel 11b of the main body 10. As such, when the locking module 300 is disposed on the rear portion of the main body 10, the worker who intends to perform work such as repair, inspection, or parts replacement on the locking module 300 may easily access the locking module 300 by separating the rear cover 11c from the main body 10, thereby improving the convenience of the work.

The position of the locking module 300 is not limited thereto, and the locking module 300 may be disposed at various positions within the main body 10. For example, the locking module 300 may be disposed on the front portion of the main body 10. However, it is appropriate for the locking module 300 to be disposed adjacent to the driving module 200.

The locking module 300 may be disposed on the upper portion of the main body 10. At least a portion of the locking module 300 may be disposed in the electrical room 50.

The locking module 300 may be fixed with respect to the main body 10. As an example, the locking module 300 may be fixed to the rear panel 11b of the main body 10. As an example, the locking module 300 may be fastened to the rear panel 11b by screws. However, the locking module 300 is not limited thereto, and may be coupled to various components in the main body 10 and fixed to the main body 10 in various ways.

As an example, the locking module 300 may include a locking module bracket 310 provided to be mounted in the main body 10. As an example, the locking module bracket 310 may be coupled to the rear panel 11b to be fixed with respect to the main body 10.

As an example, the driving module 200 and the locking module 300 may be arranged substantially in a vertical direction Z with respect to each other. As illustrated in FIG. 3, the locking module 300 may be disposed above the driving module 200. Unlike this, the locking module 300 may be disposed below the driving module 200. As the driving module 200 and the locking module 300 are arranged adjacent to each other in the vertical direction Z, a space occupied by the driving module 200 and the locking module 300 within the main body 10 may be saved, and assembly processes of components may be performed efficiently.

However, the arrangement of driving module 200 and locking module 300 is not limited thereto. Unlike what is illustrated, the locking module 300 and the driving module 200 are not arranged in the vertical direction Z with respect to each other, but may be arranged in various ways in the main body 10.

A detailed description of a structure and operation of the locking module 300 will be provided later.

FIG. 5 is a top view illustrating a portion of the main body of the cooking apparatus and the latch mounted therein according to an embodiment of the present disclosure.

Referring to FIG. 5, the latch 100 of the cooking apparatus 1 according to an embodiment of the present disclosure may be movably mounted in the main body 10. The latch 100 may be provided to be movable between the first latch position LP1 and the second latch position LP2 (see FIGS. 11, 12, etc.).

In detail, the latch 100 may be provided to be rotatable with respect to the main body 10. The latch 100 may be provided to be rotatable between the first latch position LP1 and the second latch position LP2 around a rotation axis of the latch 100. Referring to FIG. 5, the latch 100 may move to the second latch position LP2 by rotating counterclockwise from the first latch position LP1 around the rotation axis of the latch 100. Conversely, the latch 100 may move to the first latch position LP1 by rotating clockwise around the rotation axis of the latch 100 from the second latch position LP2. However, the rotation direction of the latch 100 is only an example, and the latch 100 may rotate in the opposite direction as described above. Hereinafter, a direction in which the latch 100 rotates from the first latch position LP1 to the second latch position LP2 around the rotation axis will be referred to as a first rotation direction, and a direction in which the latch 100 rotates from the second latch position LP2 to the first latch position LP1 around the rotation axis will be referred to as a second rotation direction. The first and second rotation directions are opposite to each other.

The latch 100 may be provided to be rotatable between a first latch position LP1 and a second latch position LP2 around a latch shaft 101. The rotation axis of the latch 100 may pass the latch shaft 101.

As an example, the latch shaft 101 may penetrate the latch 100. A hole is formed on the latch 100, and the latch shaft 101 may penetrate the hole formed on the latch 100.

As an example, the latch shaft 101 may have a substantially cylindrical shape having the rotation axis of the latch 100 as a central axis.

As an example, the rotation axis of the latch 100 may be arranged parallel to the vertical direction Z. The latch shaft 101 may extend in the vertical direction Z.

The latch 100 may be provided to be rotatable relative to the latch bracket 13. The latch bracket 13 may rotatably support the latch 100. The latch 100 may be coupled to the latch bracket 13 by the latch shaft 101.

The latch bracket 13 may include a bracket body 13a provided to support the latch 100. The latch 100 may be seated on the bracket body 13a. The latch 100 may be rotatably coupled to the bracket body 13a by the latch shaft 101.

The bracket body 13a may be mounted on the outer case 11. The bracket body 13a may be disposed inside the outer case 11. As an example, the bracket body 13a may be disposed in the electrical room 50. As an example, the bracket body 13a may be coupled to an inner wall of the front frame 11a.

The latch 100 may include a door support portion 110 provided to support the door 30. In detail, when the door 30 closes the cooking chamber 20 and the latch 100 is located at the first latch position LP1, the door support portion 110 may support the door 30. The door support portion 110 may support the door 30 by being caught on the door locking part 31 of the door 30. The door support portion 110 may support the door 30 by being located in front of the lock pin 31b of the door locking part 31 and coming into contact with the lock pin 31b.

In contrast, when the door 30 closes the cooking chamber 20, the door support portion 110 may release the support of the door 30 as the latch 100 rotates from the first latch position LP1 to the second latch position LP2. When the latch 100 moves from the first latch position LP1 to the second latch position LP2, the door support portion 110 may release the support of the door 30 by being separated from the door locking part 31. The door support portion 110 may release the support of the door 30 by being spaced apart from the lock pin 31b.

As an example, the door support portion 110 may be provided on one end of the latch 100. In detail, the door support portion 110 may be provided on one end of a front side of the latch 100.

As an example, the door support portion 110 may have a hook shape formed to be caught on the door locking part 31.

The latch 100 may include an inclined surface 120 provided to come into contact with the door locking part 31 when the door 30 is closed. In detail, the inclined surface 120 may be provided to be pressed by the lock pin 31b when the door 30 is closed.

When the door 30 is closed, the latch 100 may rotate as the inclined surface 120 is pressed by the lock pin 31b. In detail, when the door 30 is closed, the latch 100 may rotate in the first rotation direction as the inclined surface 120 is pressed by the lock pin 31b, and the lock pin 31b may move along a path thereof without being restricted by latch 100 as the latch 100 rotates in the first rotation direction, so that the door 30 may be closed smoothly.

The inclined surface 120 may be provided on one end of the front side of the latch 100. Furthermore, the inclined surface 120 may be positioned further forward than the door support portion 110. The inclined surface 120 may be a portion of the latch 100 that first comes into contact with the lock pin 31b when the door 30 is closed.

The latch device of the cooking apparatus 1 may include an elastic spring 102 connected to the latch 100. The elastic spring 102 may be provided to move the latch 100 to the first latch position LP1. In other words, the elastic spring 102 may be elastically biased to apply an elastic force to the latch 100 in a direction in which the latch 100 moves from the second latch position LP2 to the first latch position LP1. For example, when the latch 100 moves from the first latch position LP1 to the second latch position LP2, the elastic spring 102 may accumulate the elastic force while being deformed. When a force of locating the latch 100 in the second latch position LP2 is removed after the latch 100 reaches the second latch position LP2, the latch 100 may be returned to the first latch position LP1 by the elastic force accumulated in the elastic spring 102.

As an example, the elastic spring 102 may be a tensile spring. However, the elastic spring 102 is not limited thereto and may have various structures such as a compression spring and a torsion spring depending on a structure of being connected to the latch 100.

The elastic spring 102 may have one end connected to the latch 100 and the other end connected to the main body 10. Accordingly, when the latch 100 moves with respect to the main body 10, the elastic spring 102 may be deformed. As an example, the elastic spring 102 may have one end connected to the latch 100 and the other end connected to the latch bracket 13. The latch bracket 13 may include a spring coupling portion 13d to which the elastic spring 102 is connected. The elastic spring 102 may be deformed depending on a distance between the spring coupling portion 13d and the latch 100.

As an example, the spring coupling portion 13d may be formed by bending a portion of the bracket body 13a.

As the latch device includes the elastic spring 102 as described above, the latch 100 may be returned to the first latch position LP1 when the force of locating the latch 100 in the second latch position LP2 is removed after the latch 100 moves to the second latch position LP2.

The main body 10 may include a latch stopper 13b provided to prevent the latch 100 from further rotating in the second direction from the first latch position LP1 when the latch 100 reaches the first latch position LP1. As an example, the latch stopper 13b may be formed by bending a portion of the bracket body 13a.

The latch stopper 13b may be provided to come into contact with the latch 100 located at the first latch position LP1. The latch stopper 13b may be positioned on one side in a direction in which the latch 100 rotates in the second rotation direction relative to the latch 100 located at the first latch position LP1.

The latch 100 may include a stopper contact portion 130, and the stopper contact portion 130 may be provided to come into contact with the latch stopper 13b when the latch 100 is located at the first latch position LP1. The latch stopper 13b may be positioned on a side in the second rotation direction with respect to the stopper contact portion 130 when the latch 100 is located at the first latch position LP1. When the latch 100 rotates from the first latch position LP1 to the second latch position LP2, the stopper contact portion 130 may become away from the latch stopper 13b, and when the latch 100 rotates from the second latch position LP2 to the first latch position LP1, the stopper contact portion 130 may become close to the latch stopper 13b.

As such, as the latch stopper 13b is provided in the main body 10, the first latch position LP1 of the latch 100 may be guided, and when the latch 100 reaches the first latch position LP1, further rotation in the second rotation direction may be prevented. As described above, because the elastic spring 102 may be elastically biased to rotate the latch 100 in the second rotation direction, by the combination of the latch stopper 13b and the elastic spring 102, the latch 100 may be stably located at the first latch position LP1 as long as the force of locating the latch 100 in the second latch position LP2 is not applied.

The latch 100 may be connected to the driving module 200 (in detail, the slider 240 which will be described later) by the connecting rod 400. The latch 100 may be coupled to the connecting rod 400. The latch 100 may be coupled to one end of the connecting rod 400.

As an example, the latch 100 may be rotatably coupled to one end of the connecting rod 400. The latch 100 is rotatable relative to one end of the connecting rod 400, so that the rotation thereof may be prevented from being restricted or rotation resistance may be prevented from occurring by the connecting rod 400.

As an example, the connecting rod 400 may be coupled to a rear portion of the latch 100.

As an example, the connecting rod 400 may be caught on and coupled to the latch 100 by penetrating the latch 100. However, the latch 100 and the connecting rod 400 are not limited thereto and may be connected by various structures.

The structure of the latch 100 and the latch bracket 13 supporting the same described above with reference to FIG. 5 is only an example, and the present disclosure is not limited thereto.

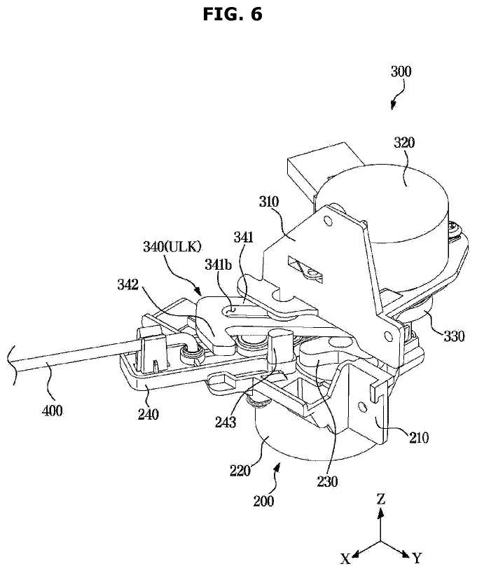

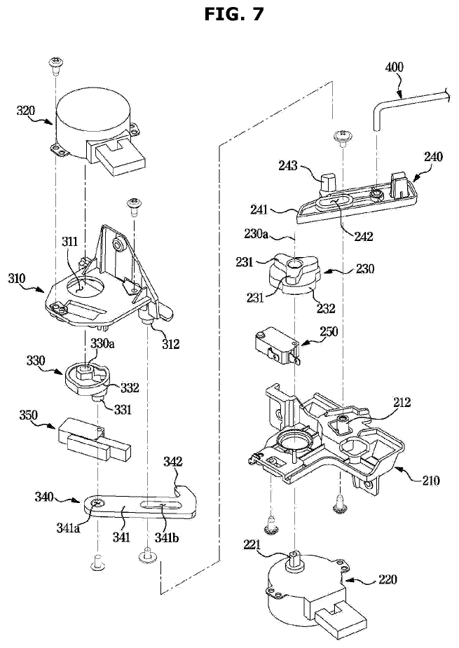

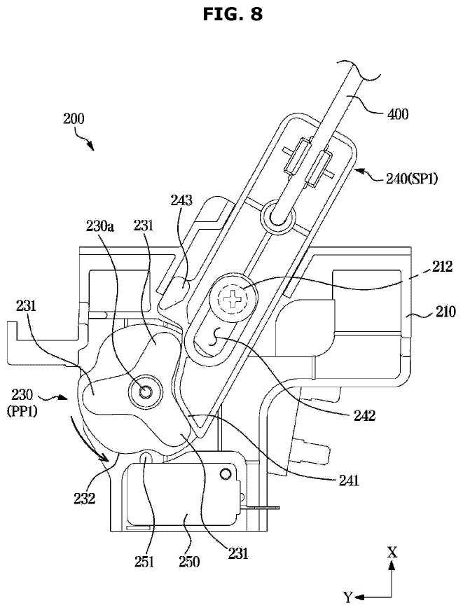

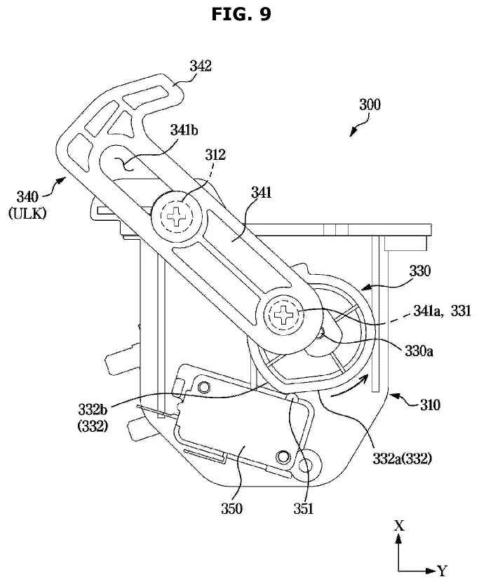

FIG. 6 is a view illustrating a driving module and a locking module of the latch device of the cooking apparatus according to an embodiment of the present disclosure. FIG. 7 is an exploded view of the driving module and the locking module of the latch device of the cooking apparatus according to an embodiment of the present disclosure. FIG. 8 is a top view of components of the driving module, such as a slider, a connecting rod, and a pusher, of the latch device of the cooking apparatus according to an embodiment of the present disclosure. FIG. 9 is a bottom view of components of the locking module, such as a locker and a cam, of the latch device of the cooking apparatus according to an embodiment of the present disclosure.

Referring to FIGS. 6 to 9, the driving module 200 of the cooking apparatus 1 according to an embodiment of the present disclosure may include a pusher 230 provided to move the latch 100 from the first latch position LP1 to the second latch position LP2. The driving module 200 may include the slider 240 provided to be movable in conjunction with the latch 100. The pusher 230 may be provided to move the slider 240, and may move the latch 100 in conjunction with the slider 240 by moving the slider 240.

In detail, the slider 240 may be provided to be movable with respect to the main body 10. The slider 240 may be provided to be movable relative to the driving module bracket 210. The slider 240 may be provided to be movable between a first slider position SP1 (see FIG. 8) and a second slider position SP2 (see FIGS. 11 and 12).

The slider 240 may be connected to the latch 100. As the slider 240 is connected to the latch 100, the slider 240 may be moved between the first slider position SP1 and the second slider position SP2 when the latch 100 moves between the first latch position LP1 and the second latch position LP2. Herein, the first slider position SP1 is defined as a position of the slider 240 when the latch 100 is located at the first latch position LP1. The second slider position SP2 is defined as a position of the slider 240 when the latch 100 is located at the second latch position LP2.

The slider 240 may be connected to the latch 100 through the connecting rod 400. The slider 240 may be coupled to the connecting rod 400. The slider 240 may be coupled to one end of the connecting rod 400.

As an example, the connecting rod 400 may be coupled to a front portion of the slider 240.

As an example, the connecting rod 400 may be caught on and coupled to the slider 240 by penetrating the slider 240. Alternatively, as an example, the connecting rod 400 may be caught on and coupled to a hook structure provided on the slider 240 (see FIG. 7 and FIG. 8). However, the slider 240 and the connecting rod 400 are not limited thereto and may be connected by various structures.

The slider 240 may be mounted on the driving module bracket 210. The slider 240 may be movably mounted on the driving module bracket 210. The slider 240 may be movably supported by the driving module bracket 210.

The driving module 200 may include a slider guide 212 provided to guide the movement of the slider 240. The slider guide 212 may guide the slider 240 when the slider 240 moves between the first slider position SP1 and the second slider position SP2.

As an example, a slider rail 242 may be formed on the slider 240, and the slider guide 212 may guide the movement of the slider 240 by being inserted into the slider rail 242. As an example, the slider rail 242 may be formed in the shape of a slot formed by cutting out a portion of the slider 240.

Unlike this, as an example, a structure may be provided in which the slider guide 212 has the shape of a rail and a portion of the slider 240 is inserted into the slider guide 212 so that the slider 240 is guided by the slider guide 212.

The slider guide 212 may be fixed with respect to the main body 10. As an example, the slider guide 212 may be provided on the driving module bracket 210.

The slider 240 may be provided to be linearly movable with respect to the main body 10. The slider 240 may be provided to be linearly movable relative to the driving module bracket 210. That is, the slider 240 may be provided to be linearly movable between the first slider position SP1 and the second slider position SP2. The slider guide 212 may guide the slider 240 so that the slider 240 moves linearly.

However, the movement path of the slider 240 is not limited thereto, and for example, the slider 240 may be provided to move along a curved path. In this case, the structure of the slider rail 242, etc., may have a curved shape corresponding to the movement path of the slider 240.

As an example, the slider 240 may be coupled to the slider guide 212 of the driving module bracket 210. In detail, as the slider guide 212 is inserted into the slider rail 242 of the slider 240, the slider 240 may be mounted on the driving module bracket 210. In this case, the slider 240 and the slider guide 212 may be firmly fastened to each other by a fastening member (e.g., a screw, etc.) penetrating the slider guide 212.

The pusher 230 may be provided to press the slider 240. The pusher 230 may be provided to press the slider 240 to move the slider 240 from the first slider position SP1 to the second slider position SP2.

The pusher 230 may be located at a first pusher position PP1 (see FIG. 8). Or, the pusher 230 may be located at a second pusher position PP2 (see FIG. 11). The pusher 230 may be provided to be movable to the first pusher position PP1 or the second pusher position PP2.

The pusher 230 may not press the slider 240 when located at the first pusher position PP1. That is, the first pusher position PP1 is defined as a position at which the pusher 230 releases from pressing the slider 240. In other words, the pusher 230 may release from pressing the slider 240 to the second slider position SP2 when located at the first pusher position PP1.

The pusher 230 may be provided to move the slider 240 located at the first slider position SP1 to the second slider position SP2 when moving from the first pusher position PP1 to the second pusher position PP2. The pusher 230 may move the slider 240 located at the first slider position SP1 to the second slider position SP2 by pressing one end 241 of the slider 240 adjacent to the pusher 230 while moving from the first pusher position PP1 to the second pusher position PP2. Accordingly, the latch 100 interlocked with the slider 240 may move from the first latch position LP1 to the second latch position LP2.

The pusher 230 may release from pressing the slider 240 to the second slider position SP2 when moving from the second pusher position PP2 to the first pusher position PP1. As illustrated in FIGS. 7 and 8, the pusher 230 and the slider 240 may be configured to be separated without being coupled to each other. That is, the slider 240 may be provided to be movable relative to the pusher 230. Therefore, as will be described later, even when the pusher 230 is located at the first pusher position PP1 and does not press the slider 240, the slider 240 is not necessarily located at the first slider position SP1, and the slider 240 may be located at the second slider position SP2 and the latch 100 may also be located at the second latch position LP2.

The first pusher position PP1 is defined as a position in which the pusher 230 does not press the slider 240, and the first pusher position PP1 of the pusher 230 is not necessarily defined as a single specific position. The second pusher position PP2 is defined as a position in which the pusher 230 presses the slider 240, and the second pusher position PP2 of the pusher 230 is not necessarily defined as a single specific position. For example, as will be described later, the pusher 230 may include a plurality of contact portions 231, and the plurality of contact portions 231 may be provided to press the slider 240 one by one. Accordingly, a position at which any one of the plurality of contact portions 231 presses the slider 240 may be defined as the second pusher position PP2. Herein, a number of the second pusher positions PP2 may correspond to a number of contact portions 231. The first pusher position PP1 may be defined as a position when all of the plurality of contact portions 231 do not press the slider 240, and the first pusher position PP1 may be defined as a position between the second pusher positions PP2. Herein, a number of the first pusher positions PP1 may correspond to a number of regions between the plurality of contact portions 231.

The pusher 230 may be provided to be rotatable with respect to the main body 10. The pusher 230 may be provided to be rotatable relative to the driving module bracket 210. The pusher 230 may be provided to be rotatable around a rotation axis 230a of the pusher 230. As an example, the rotation axis 230a of the pusher 230 may extend parallel to the vertical direction Z, but a direction in which the rotation axis 230a of the pusher 230 extends is not limited thereto. The pusher 230 may rotate from the first pusher position PP1 to the second pusher position PP2 around the rotation axis 230a. Or, the pusher 230 may rotate from the second pusher position PP2 to the first pusher position PP1 around the rotation axis 230a.

As an example, the pusher 230 may be provided to rotate in one direction around the rotation axis 230a. That is, a direction in which the pusher 230 rotates from the first pusher position PP1 to the second pusher position PP2 and a direction in which the pusher 230 rotates from the second pusher position PP2 to the first pusher position PP1 may be the same. Hereinafter, one direction in which the pusher 230 rotates around the rotation axis 230a will be referred to as a ‘pusher rotation direction’.

The pusher 230 may include the contact portion 231 provided to press the slider 240 when the pusher 230 rotates from the first pusher position PP1 to the second pusher position PP2. The contact portion 231 may be provided to come into contact with the slider 240 and press the slider 240 from the first slider position SP1 toward the second slider position SP2 when the pusher 230 rotates from the first pusher position PP1 to the second pusher position PP2.

As an example, the contact portion 231 may extend from the rotation axis 230a of the pusher 230 in a radial direction of the pusher 230.

The pusher 230 may include the plurality of contact portions 231. When the pusher 230 rotates from the first pusher position PP1 to the second pusher position PP2, at least some of the plurality of contact portions 231 may come into contact with the slider 240 and press the slider 240 to the second slider position SP2. As an example, when the pusher 230 rotates from the first pusher position PP1 to the second pusher position PP2, the plurality of contact portions 231 may press the slider 240 to the second slider position SP2 one by one. The plurality of contact portions 231 may be arranged along the rotation direction of the pusher 230. As the pusher 230 rotates in the pusher rotation direction, the plurality of contact portions 231 may come into contact with the slider 240 in an arranged order and may press the slider 240.

As illustrated in FIG. 8, when the pusher 230 is located at the first pusher position PP1 and the slider 240 is located at the first slider position SP1, the slider 240 may be located between a pair of the adjacent contact portions 231 among the plurality of contact portions 231. When the pusher 230 rotates in the pusher rotation direction from the first pusher position PP1 to the second pusher position PP2, one of the plurality of contact portions 231 may press the slider 240 to the second slider position SP2 (see FIG. 11). The pusher 230 reaches the second pusher position PP2 as the pusher 230 rotates again in the pusher rotation direction from the second pusher position PP2, and when the slider 240 returns to the first slider position SP1, the slider 240 may again be located between a pair of the adjacent contact portions 231 among the plurality of contact portions 231, as illustrated in FIG. 8.

As an example, as illustrated in FIG. 8, the plurality of contact portions 231 may be arranged at regular intervals from each other. In this case, the pusher 230 may rotate at a constant speed and move to the first pusher position PP1 or to the second pusher position PP2. That is, the pusher 230 may rotate at the constant speed and press or release the slider 240.

FIG. 8 illustrates an embodiment in which the pusher 230 includes the three contact portions 231, but the number of the contact portions 231 included in the pusher 230 may be designed differently depending on a rotational speed per minute (rpm) by a first driving source 220 connected to the pusher 230. In detail, in order to maintain an operating time of the latch 100 within a predetermined range, it is appropriate to design the number of the contact portions 231 included in the pusher 230 to increase as the rotational speed per minute (rpm) by the first driving source 220 decreases, and correspondingly, an angle between a pair of the adjacent contact portions 231 among the plurality of contact portions 231 may be reduced.

As an example, the plurality of contact portions 231 may be connected to each other and formed as a single unit. Unlike this, the plurality of contact portions 231 may be formed separately from each other.

By this configuration, the pusher 230 may move the slider 240 from the first slider position SP1 to the second slider position SP2.

Unlike what is described above, the pusher 230 may be provided to rotate in one direction from the first pusher position PP1 toward the second pusher position PP2 and to rotate in the other direction, which is opposite to the one direction, from the second pusher position PP2 toward the first pusher position PP1.

As such, in order to provide a driving force to the pusher 230 for the pusher 230 to move with respect to the main body 10, the driving module 200 may include the first driving source 220. The first driving source 220 may be provided to generate a driving force. The first driving source 220 may be provided to provide the generated driving force to the pusher 230.

As an example, the first driving source 220 may include a motor. The first driving source 220 may include various types of previously known motors.

As an example, the first driving source 220 may receive a driving current from a motor driver through wires, etc.

The first driving source 220 may provide the driving force to the pusher 230 by being connected directly or indirectly to the pusher 230. As an example, the first driving source 220 may be connected to the pusher 230 through a rotor shaft 221. The first driving source 220 may provide the driving force to the pusher 230 through the rotor shaft 221. The pusher 230 may rotate with respect to the main body 10 by receiving the driving force from the rotor shaft 221.

As an example, the first driving source 220 may be mounted on the driving module bracket 210.

The driving module 200 may include a pusher position detection sensor 250 provided to detect a position of the pusher 230. The pusher position detection sensor 250 may be provided to output an electrical signal corresponding to the position of the pusher 230.

For example, as illustrated in FIG. 8, the pusher position detection sensor 250 may include a pusher switch 251 provided to generate an electrical signal depending on whether a pressure is applied. In other words, an electrical signal output from the pusher position detection sensor 250 when the pusher switch 251 is pressed and an electrical signal output from the pusher position detection sensor 250 when the pusher switch 251 is not pressed may be different from each other.

For example, a circuit of the pusher position detection sensor 250 may become a state of being turned on when the pusher switch 251 is pressed and may become a state of being turned off when the pusher switch 251 is not pressed. Or, for example, the circuit of the pusher position detection sensor 250 may become the state of being turned on when the pusher switch 251 is not pressed and may become the state of being turned off when the pusher switch 251 is pressed. This may vary depending on how the circuit of the pusher position detection sensor 250 is configured.

As an example, the pusher position detection sensor 250 may include a micro switch.

The pusher 230 may press or may not press the pusher switch 251 depending on the position thereof. The pusher 230 may include a cam surface 232 formed along an outer circumference of the pusher 230. The cam surface 232 may press or not press the pusher switch 251 as the pusher 230 rotates around the rotation axis 230a. As an example, the cam surface 232 may be provided not to press the pusher switch 251 by being spaced apart from the pusher switch 251 when the pusher 230 is located at the first pusher position PP1 and to press the pusher switch 251 when the pusher 230 is located at the second pusher position PP2. Conversely, the cam surface 232 may be provided to press the pusher switch 251 when the pusher 230 is located at the first pusher position PP1 and not to press the pusher switch 251 by being spaced apart from the pusher switch 251 when the pusher 230 is located at the second pusher position PP2.

In addition, the pusher position detection sensor 250 may include various types of sensors, such as a hall sensor, a magnetic field sensor like a reed switch, and a light sensor.

By this configuration, the pusher position detection sensor 250 may be provided to detect whether the pusher 230 is located at the first pusher position PP1 or at the second pusher position PP2. The pusher position detection sensor 250 may output an electrical signal for the position of the pusher 230, and a controller of the cooking apparatus 1 may control the first driving source 220 based on the electrical signal received from the pusher position detection sensor 250.

By this configuration, the driving module 200 may move the latch 100 from the first latch position LP1 to the second latch position LP2 using components such as the first driving source 220, the pusher 230, and the door 30 may be opened. On the other hand, as will be described later, the slider 240 is movable together with the latch 100 even when the first driving source 220 does not operate and the pusher 230 does not rotate, so that the door 30 may be opened when the user applies a sufficient force to the door 30. However, in various cases for user safety, the door 30 may need to be secured more firmly in the closed position, and to this end, the cooking apparatus 1 according to an embodiment may include the locking module 300 configured to completely lock the door 30 by restricting the movement of the latch 100 and the slider 240.

The locking module 300 may include a locker 340. In detail, the locker 340 may be provided to restrict the latch 100 from moving from the first latch position LP1 to the second latch position LP2 or to allow the latch 100 to move from the first latch position LP1 to the second latch position LP2. The latch 100 may be restricted from moving or allowed to move depending on a position of the locker 340.

In detail, the locker 340 may be provided to restrict or allow the movement of the slider 240. The locker 340 may be provided to restrict the slider 240 from moving from the first slider position SP1 to the second slider position SP2 or to allow the slider 240 to move between the first slider position SP1 and the second slider position SP2. When the locker 340 restricts the movement of the slider 240, the latch 100 connected to the slider 240 may also be restricted from moving. When the locker 340 allows the slider 240 to move, the latch 100 may also be allowed to move.

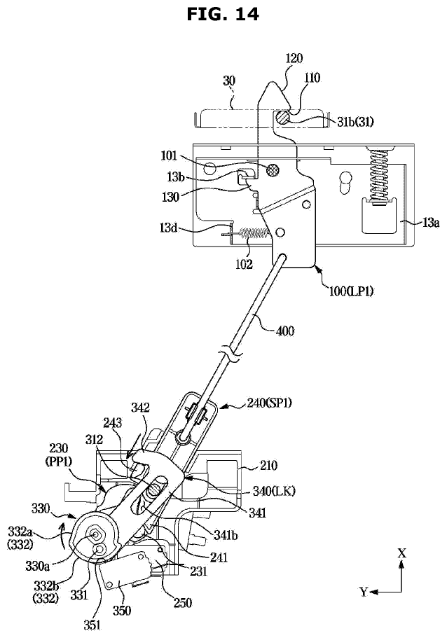

The locker 340 may be provided to be movable with respect to the main body 10. The locker 340 may be provided to be movable relative to the locking module bracket 310. The locker 340 may restrict or allow the slider 240 to move from the first slider position SP1 to the second slider position SP2 depending on a relative position to the main body 10. Hereinafter, the position of the locker 340 when the locker 340 restricts the movement of the slider 240 from the first slider position SP1 to the second slider position SP2 will be referred to as a locking position LK (see FIG. 14). In addition, the position of the locker 340 when the locker 340 allows the movement of the slider 240 between the first slider position SP1 and the second slider position SP2 will be referred to as an unlocking position ULK (see FIGS. 6 and 9). The locker 340 may be provided to be movable between a locking position LK and an unlocking position ULK with respect to the main body 10. The locker 340 may be provided to be movable between the locking position LK and the unlocking position ULK relative to the locking module bracket 310.

The locker 340 may be provided to be caught on the slider 240 when the slider 240 is located at the first slider position SP1 and the locker 340 is located at the locking position LK. The locker 340 may be caught on the slider 240 when located at the locking position LK and secure the slider 240. The locker 340 may allow the slider 240 to move with respect to the main body 10 by being spaced apart from the slider 240 when located at the unlocking position ULK.

The locker 340 may include a hook portion 342. The hook portion 342 may be provided to be caught on the slider 240 when the slider 240 is located at the first slider position SP1 and the locker 340 is located at the locking position LK.

The slider 240 may include a caught portion 243. The caught portion 243 may be provided to be caught on the hook portion 342 when the slider 240 is located at the first slider position SP1 and the locker 340 is located at the locking position LK. The caught portion 243 may be provided to be spaced apart from the hook portion 342 when the slider 240 is located at the first slider position SP1 and the locker 340 is located at the unlocking position ULK.

The locker 340 may include a locker body 341. The hook portion 342 may protrude from the locker body 341.

The hook portion 342 may protrude from one end of the locker body 341. As an example, the locker body 341 may extend in one direction, and the hook portion 342 may protrude in a direction different from the one direction from the one end in the one direction of the locker body 341. As an example, the hook portion 342 may protrude in a horizontal direction from a front end of the locker body 341. In detail, the hook portion 342 may protrude from the front end of the locker body 341 in a direction toward the caught portion 243 of the slider 240.

The hook portion 342 may be provided at one end of the locker 340 in a direction in which the locker 340 moves from the unlocking position ULK to the locking position LK. As an example, the hook portion 342 may be provided at a front end of the locker 340. That is, the hook portion 342 may protrude from the front end of the locker body 341.

The caught portion 243 of the slider 240 may protrude in a vertical direction from a body portion of the slider 240. As illustrated in FIG. 6, when the locker 340 covers at least a portion of the slider 240 from above, the caught portion 243 may protrude upward from the body portion of the slider 240. Unlike this, when the locker 340 covers at least a portion of the slider 240 from below, the caught portion 243 may protrude downward from the body portion of the slider 240.

However, the shapes of the hook portion 342 and the caught portion 243 are not limited to those described above, and the hook portion 342 and the caught portion 243 may have various structures of being capable of being engaged with each other when the locker 340 is located in the locking position LK.

The locker 340 may cover at least a portion of the slider 240. For example, the locker 340 may cover at least a portion of the slider 240 in a direction parallel to the vertical direction Z of the main body 10. As illustrated in FIG. 6, the locker 340 may cover at least a portion of the slider 240 from above. Unlike this, the locker 340 may cover at least a portion of the slider 240 from below. As the locker 340 covers at least a portion of the slider 240, a space occupied by the locker 340 and the slider 240 within the main body 10 may be saved. Additionally, assembly processes of components such as the locker 340 and the slider 240 may be efficiently performed within the main body 10.

The locker 340 may be mounted on the locking module bracket 310. The locker 340 may be movably mounted on the locking module bracket 310. The locker 340 may be movably supported by the locking module bracket 310. In other words, the locker body 341 may be movably mounted on the locking module bracket 310.

The locking module 300 may include a locker guide 312 provided to guide the movement of the locker 340. The locker guide 312 may guide the locker 340 when the locker 340 moves between the locking position LK and the unlocking position ULK.

As an example, a locker rail 341b may be formed on the locker 340, and the locker guide 312 may be inserted into the locker rail 341b to guide the movement of the locker 340. As an example, the locker rail 341b may be formed in the shape of a slot formed by cutting out a portion of the locker body 341.

Unlike this, as an example, a structure may be provided in which the locker guide 312 has the shape of a rail and a portion of the locker body 341 is inserted into the locker guide 312 so that the locker 340 is guided by the locker guide 312.

The locker guide 312 may be fixed with respect to the main body 10. As an example, the locker guide 312 may be provided on the locking module bracket 310.

The locker 340 may be provided to be movable back and forth between the locking position LK and the unlocking position ULK. The locker guide 312 may guide the locker 340 to move back and forth between the locking position LK and the unlocking position ULK.

As an example, the locker 340 may be coupled to the locker guide 312 of the locking module bracket 310. In detail, as the locker guide 312 is inserted into the locker rail 341b, the locker 340 may be mounted on the locking module bracket 310. In this case, the locker 340 and the locker guide 312 may be securely fastened to each other by a fastening member (e.g., screw, etc.) penetrating the locker guide 312.

The locking module 300 may include a second driving source 320 provided to generate a driving force. The second driving source may be configured to generate a driving force for the locker 340 to move with respect to the main body 10. In detail, the second driving source 320 may be provided to provide the generated driving force to a locking cam 330, which will be described later.

As an example, the second driving source 320 may include a motor. The second driving source 320 may include various types of previously known motors.

As an example, the second driving source 320 may receive a driving current from a motor driver through wires, etc.

As an example, the second driving source 320 may be mounted on the locking module bracket 310. As an example, the second driving source 320 may be fixed to one side of the locking module bracket 310, and the locking cam 330 connected to the second driving source 320 may be disposed on the other side of the locking module bracket 310. The locking cam 330 may be connected to the second driving source 320 by a rotor shaft of the second driving source 320 penetrating a rotor shaft penetration portion 311 formed in the locking module bracket 310.

As the first driving source 220 for driving the latch 100, slider 240, and pusher 230 and the second driving source 320 for driving the locker 340 and locking cam 330 are each provided, operations of the driving module 200 and the locking module 300 may be efficiently controlled. Additionally, as the first driving source 220 and the second driving source 320 are each provided, even if any one of the two driving sources is damaged or the wires or other components connected to any one of the two driving sources are damaged, the other driving source may still be able to operate.

The locking module 300 may include the locking cam 330. The locking cam 330 may be provided to transmit the driving force generated from the second driving source 320 to the locker 340. The locking cam 330 may be provided to move the locker 340 between the locking position LK and the unlocking position ULK.

The locking cam 330 may be provided to be rotatable with respect to the main body 10. The locking cam 330 may be provided to be rotatable relative to the locking module bracket 310. The locking cam 330 may be provided to be rotatable around a cam rotation axis 330a. As an example, the cam rotation axis 330a may extend substantially parallel to the vertical direction Z. However, the cam rotation axis 330a is not limited thereto and may extend in various directions.

The locking cam 330 may receive the driving force generated from the second driving source 320. As an example, the second driving source 320 may be connected to the locking cam 330 through the rotor shaft. The locking cam 330 may receive the driving force by being connected to the rotor shaft of the second driving source 320. The locking cam 330 may be provided to be rotatable around the cam rotation axis 330a by the driving force transmitted from the second driving source 320.

The rotation axis of the locking cam 330 may be disposed parallel to the rotor shaft of the second drive source 320. Furthermore, the rotation axis of the locking cam 330 may be disposed substantially in a straight line with the rotor shaft of the second driving source 320.

The locker 340 may be connected to the locking cam 330. As the locker 340 is connected to the locking cam 330, the locker 340 may be provided to be rotatable between the locking position LK and the unlocking position ULK when the locking cam 330 rotates. In detail, the locking cam 330 may be connected to the locker body 341. The locker body 341 may include a connection portion 341a connected to the locking cam 330. The locking cam 330 may include a locker connection shaft 331 connected to the connection portion 341a. When the locking cam 330 rotates, the locker 340 may move by receiving the driving force through the locker connection shaft 331.

The locker 340 may be provided to be rotatable relative to the locking cam 330. The locker 340 may be provided to be rotatable around the locker connection shaft 331. That is, the locker connection shaft 331 may function as a rotation axis of the locker 340.

The locker connection shaft 331 may be parallel to the cam rotation axis 330a. As an example, the locker connection shaft 331 may extend substantially parallel to the vertical direction Z.

The rotation axis of the locker 340 may be disposed to be spaced apart from the cam rotation axis 330a. The locker connection shaft 331 may be disposed to be spaced apart from the cam rotation axis 330a. In detail, the locker connection shaft 331 and the cam rotation axis 330a may be disposed to be spaced apart from each other in the horizontal direction. Accordingly, rotational motion of the locking cam 330 may be converted into substantially linear motion of the locker 340.

As an example, the locker 340 and the locking cam 330 may be coupled to each other as the locker connection shaft 331 is inserted into the connection portion 341a.

As an example, the locker connection shaft 331 may be formed in a substantially cylindrical shape. As an example, the connection portion 341a may be formed in a substantially circular hole shape.

Unlike this, the locking cam 330 may have a groove formed therein that is disposed to be spaced apart from the cam rotation axis 330a and through which the rotation axis of the locker 340 passes, and the locker 340 may have a structure having a shaft that passes through the groove.

The locking cam 330 may be provided to rotate in one direction around the cam rotation axis 330a. In other words, a direction in which the locking cam 330 rotates around the cam rotation axis 330a when the locker 340 moves from the unlocking position ULK to the locking position LK and a direction in which the locker 340 rotates around the cam rotation axis 330a when the locker 340 moves from the locking position LK to the unlocking position ULK may be the same. One direction in which the locking cam 330 rotates around the cam rotation axis 330a will be referred to as a ‘cam rotation direction’. For example, as the locking cam 330 rotates in the cam rotation direction around the cam rotation axis 330a, the locker 340 located at the unlocking position ULK may move to the locking position LK. In addition, as the locking cam 330 rotates in the cam rotation direction around the cam rotation axis 330a, the locker 340 located at the locking position LK may move to the unlocking position ULK.

Unlike this, as an example, the direction in which the locking cam 330 rotates around the cam rotation axis 330a when the locker 340 moves from the unlocking position ULK to the locking position LK and the direction in which the locker 340 rotates around the cam rotation axis 330a when the locker 340 moves from the locking position LK to the unlocking position ULK may be opposite to each other.

The locking module 300 may include a cam position detection sensor 350 provided to detect a position of the locking cam 330. The cam position detection sensor 350 may be provided to output an electrical signal corresponding to the position of the locking cam 330.

For example, as illustrated in FIG. 9, the cam position detection sensor 350 may include a cam switch 351 provided to generate an electrical signal depending on whether a pressure is applied. In other words, an electrical signal output from the cam position detection sensor 350 when the cam switch 351 is pressed and an electrical signal output from the cam position detection sensor 350 when the cam switch 351 is not pressed may be different from each other. As an example, the cam position detection sensor 350 may include a micro switch.

The locking cam 330 may press or may not press the cam switch 351 depending on the position thereof. The locking cam 330 may include a cam surface 332 formed along an outer circumference of the locking cam 330. The cam surface 332 may press or not press the cam switch 351 as the locking cam 330 rotates. As an example, the cam surface 332 may be provided not to press the cam switch 351 by being spaced apart from the cam switch 351 when the locker 340 is located at the unlocking position ULK and to press the cam switch 351 when the locker 340 is located at the locking position LK. Conversely, the cam surface 332 may be provided to press the cam switch 351 when the locker 340 is located at the unlocking position ULK and not to press the cam switch 351 by being spaced apart from the cam switch 351 when the locker 340 is located at the locking position LK.

Because the position of the locking cam 330 is linked to the position of the locker 340, the controller of the cooking apparatus 1 may control the second driving source 320 based on the electrical signal received from the cam position detection sensor 350.

In addition, the cam position detection sensor 350 may include various types of sensors, such as a hall sensor, a magnetic field sensor like a reed switch, and a light sensor.

A detailed description of a feature of detecting the position of the locking cam 330 using the cam position detection sensor 350 will be provided later.

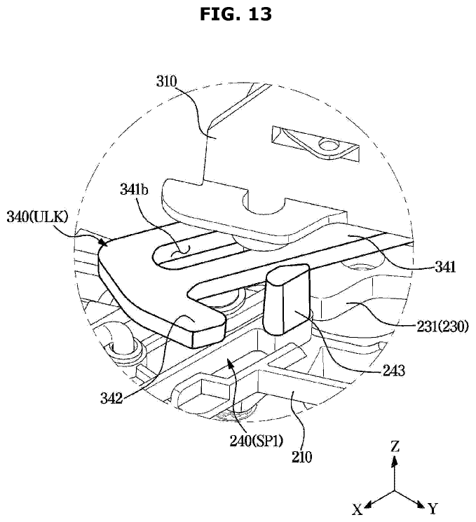

FIG. 10 is a view illustrating an appearance of the latch device when the door of the cooking apparatus is closed according to an embodiment of the present disclosure. FIG. 11 is a view illustrating the latch device that operates to open the door when a locker of the latch device of the cooking apparatus is located at an unlocking position according to an embodiment of the present disclosure. FIG. 12 is a view illustrating the latch device when the door is forcibly opened in a state where the driving module is not operating and when the locker of the latch device of the cooking apparatus is located at the unlocking position according to an embodiment of the present disclosure. FIG. 13 is a view illustrating a state in which the locker of the latch device of the cooking apparatus is located at the unlocking position according to an embodiment of the present disclosure.

Referring to FIGS. 10 to 13, the slider 240 of the cooking apparatus 1 according to an embodiment of the present disclosure may be provided to be movable between the first slider position SP1 and the second slider position SP2 when the locker 340 is located at the unlocking position ULK.

When the slider 240 is located at the first slider position SP1 and the locker 340 is located at the unlocking position ULK, the hook portion 342 of the locker 340 may be disposed to be spaced apart from the slider 240. In detail, the hook portion 342 may be disposed to be spaced apart from the caught portion 243 of the slider 240. The hook portion 342 may be positioned on one side in a direction in which the slider 240 moves from the first slider position SP1 to the second slider position SP2 with respect to the caught portion 243. By this structure, the slider 240 may be movable between the first slider position SP1 and the second slider position SP2 without being caught by the hook portion 342 of the locker 340.

As an example, when the slider 240 is located at the first slider position SP1 and the locker 340 is located at the unlocking position ULK, the hook portion 342 may be located in front of the caught portion 243.

As described above, the locking module 300 may be provided with the cam position detection sensor 350, and as an example, the cam position detection sensor 350 may include the cam switch 351 provided to generate an electrical signal depending on whether a pressure is applied. The locking cam 330 may press or may not press the cam switch 351 depending on the position thereof. The locking cam 330 may press or may not press the cam switch 351 while rotating around the cam rotation axis 330a. In detail, while the locking cam 330 rotates around the cam rotation axis 330a, the cam surface 332 of the locking cam 330 may press or may not press the cam switch 351.

For example, a circuit of the cam position detection sensor 350 may become a state of being turned on when the cam switch 351 is pressed and may become a state of being turned off when the cam switch 351 is not pressed. Or, for example, the circuit of the cam position detection sensor 350 may become the state of being turned on when the cam switch 351 is not pressed and may become the state of being turned off when the cam switch 351 is pressed. This may vary depending on how the circuit of the cam position detection sensor 350 is configured.

The cam surface 332 of the cam 330 may include a first region 332a and a second region 332b, and a radius of the second region 332b from the cam rotation axis 330a may be larger than a radius of the first region 332a. That is, the second region 332b may protrude further toward an outer side of a radius of the cam 330 than the first region 332a.

The cam position detection sensor 350 may detect the position of the lock cam 330 when the locker 340 is located at the unlocking position ULK using the cam switch 351. In addition, the cam position detection sensor 350 may detect the position of the locking cam 330 while the locker 340 is moving from the locking position LK to the unlocking position ULK using the cam switch 351.

As an example, as illustrated in FIGS. 10 to 12, when the locker 340 is located at the unlocking position ULK, the cam 330 may not press the cam switch 351. When the locker 340 is located at the unlocking position ULK, the cam 330 may be spaced apart from the cam switch 351. In detail, when the locker 340 is located at the unlocking position ULK, the first region 332a of the cam surface 332 may face the cam switch 351, and the first region 332a may be formed not to press the cam switch 351. Additionally, the cam surface 332 may be provided such that the first region 332a of the cam surface 332 faces the cam switch 351 while the locker 340 is moving from the locking position LK to the unlocking position ULK, and the first region 332a may be formed not to press the cam switch 351.

The controller of the cooking apparatus 1, which is electrically connected to the cam position detection sensor 350, may identify the position of the locking cam 330 based on the electrical signal output from the cam position detection sensor 350. The controller of the cooking apparatus 1 may identify that the locker 340 is located at the unlocking position ULK based on the electrical signal output from the cam position detection sensor 350. Alternatively, the controller of the cooking apparatus 1 may identify that the locker 340 is moving from the locking position LK to the unlocking position ULK based on the electrical signal output from the cam position detection sensor 350. The controller of the cooking apparatus 1 may control the second driving source 320 so that the locker 340 may be located at a set position based on the electrical signal output from the cam position detection sensor 350 as described above.

Thereinafter, operations of the latch 100, slider 240, and pusher 230 when the locker 340 is located at the unlocking position ULK will be described.

Referring to FIG. 10, when the door 30 closes the cooking chamber 20 and the latch 100 is located at the first latch position LP1, the latch 100 may support the door 30 so that the door 30 is not opened. In this case, the latch 100 may be in a state of being caught on the door locking part 31.

In detail, when the door 30 closes the cooking chamber 20 and the latch 100 is located at the first latch position LP1, the latch 100 may come into contact with the lock pin 31b of the door locking part 31. When the door 30 closes the cooking chamber 20 and the latch 100 is located at the first latch position LP1, the latch 100 may come into contact with a front side of the lock pin 31b.

For example, the door 30 may have a tendency to rotate in a direction in which the door 30 is opened due to its self-weight or the like. Alternatively, for example, the hinge 40 may include a structure of applying a force to the door 30 in the direction in which the door 30 is opened (e.g., including an elastic spring, etc.) so that the door 30 may be easily opened. By this structure, the door 30 may have a tendency to rotate in the direction in which the door 30 is opened. Accordingly, in a case where the latch 100 is located at the first latch position LP1 when the door 30 closes the cooking chamber 20, the lock pin 31b provided on the door 30 may come into contact with the latch 100, and thus, the latch 100 may support the door 30.

As described above, when the latch 100 is located at the first latch position LP1, the slider 240 may be correspondingly located at the first slider position SP1. When the slider 240 is located at the first slider position SP1, the pusher 230 may be located at the first pusher position PP1.

Referring to FIG. 11, the cooking apparatus 1 may be configured such that the door 30 may be automatically opened by the operations of the driving module 200 and the latch 100 when the locker 340 is located at the unlocking position ULK.

When the pusher 230 rotates from the first pusher position PP1 to the second pusher position PP2, the slider 240 may move from the first slider position SP1 to the second slider position SP2 by being pressed by the pusher 230.

As an example, the slider 240 may be provided to be linearly movable between the first slider position SP1 and the second slider position SP2.

As an example, the second slider position SP2 may be located further in front than the first slider position SP1, and the slider 240 located at the first slider position SP1 may move forward toward the second slider position SP2.

As an example, the slider 240 may move in a direction of becoming close to the rotation axis of the latch 100 when moving from the first slider position SP1 to the second slider position SP2. Conversely, the slider 240 may move in a direction of becoming away from the rotation axis of the latch 100 when moving from the second slider position SP2 to the first slider position SP1.

However, a relative position between the first slider position SP1 and the second slider position SP2 may vary depending on a connection structure between the latch 100 and the slider 240. For example, depending on the connection structure between the latch 100 and the slider 240, the first slider position SP1 may be located in the front further than the second slider position SP2, and the first slider position SP1 and the second slider position SP2 may be located side by side in a left-right direction.

As the slider 240 moves from the first slider position SP1 to the second slider position SP2, the latch 100 may be separated from the door locking part 31 by moving from the first latch position LP1 to the second latch position LP2. In this case, as described above, because the door 30 may have a tendency to rotate in the direction in which the door 30 is opened due to its self-weight or the like, the door 30 may open on its own even without any external force being applied. Alternatively, the cooking apparatus 1 may have a separate structure of inducing the opening of the door 30 when the latch 100 moves to the second latch position LP2.

When the door 30 is opened and the pusher 230 moves from the second pusher position PP2 to the first pusher position PP1, the latch 100 may be returned from the second latch position LP2 to the first latch position LP1 by a restoring force of the elastic spring 102. The slider 240 connected to the latch 100 may be returned from the second slider position SP2 to the first slider position SP1.

The operation of automatically opening the door 30 described with reference to FIG. 11 (hereinafter referred to as a “door opening operation”) may be performed based on a door opening signal being input, which is a user input for opening the door 30. The controller of the cooking apparatus 1 may drive the first driving source 220 based on the door opening signal.

As an example, the door opening signal may be input through the user interface 60. Components of the user interface 60 capable of receiving the door opening signal may include, but are not limited to, the input button 61 and the like illustrated in FIGS. 1 and 2. The user interface 60 may transmit the inputted door opening signal to the controller of the cooking apparatus 1.

Alternatively, as an example, the cooking apparatus 1 may include a microphone module capable of detecting sound, and the door opening signal may be input through the microphone module. The microphone module may detect various types of sounds that the user is capable of producing using a body thereof, such as a voice of the user. The microphone module may transmit the inputted door opening signal to the controller of the cooking apparatus 1.

Alternatively, as an example, the cooking apparatus 1 may include a motion detection module for detecting user motion, and the door opening signal may be input through the motion detection module. The motion detection module may include various types of modules capable of detecting user motion, such as a light sensor like an infrared sensor, a camera module, etc. The motion detection module may transmit the inputted door opening signal to the controller of the cooking apparatus 1.

Alternatively, as an example, the cooking apparatus 1 may include a communication module for performing communication with an external electronic device. The communication module may perform communication with the external electronic device using wired or wireless communication. The external electronic device may include a user terminal such as a smartphone. The external electronic device may include a server device. The external electronic device may transmit the door opening signal to the communication module of the cooking apparatus 1, and the communication module may process the received door opening signal and transmit the processed signal to the controller.

As an example, the door opening operation may be performed under one condition that the door 30 is in a closed state. In detail, the cooking apparatus 1 may include a door opening detection sensor for detecting whether the door 30 is opened. The door opening detection sensor may output an electrical signal corresponding to the opening or closing of the door 30 and transmit the outputted signal to the controller of the cooking apparatus 1. The controller of the cooking apparatus 1 may perform the door opening operation based on the door opening signal being input and the door 30 being closed.

As such, the controller receiving and processing the door opening signal may be composed of the same module as the controller driving the first driving source 220 or may be composed of a separate module.

There may be a case where the door 30 needs to be opened even when the driving module 200 does not operate due to a simple intention or need of the user. For example, there may be a case where the driving module 200 may not operate due to reasons such as damage to the first driving source 220 or the components of the cooking apparatus 1 required to control the first driving source 220, a power supply supplying power to the cooking apparatus 1 being cut off, or damage to the components receiving the door opening signal of the user. In such the case, the door 30 needs to be opened even when the components are not repaired or replaced. Accordingly, in an embodiment, the slider 240 may be configured to be movable from the first slider position SP1 to the second slider position SP2 even when not pressed by the pusher 230.

Referring to FIG. 12, the slider 240 may be provided to be movable relative to the pusher 230. In detail, the slider 240 may be provided to be movable between the first slider position SP1 and the second slider position SP2 when the pusher 230 is located at the first pusher position PP1. The pusher 230 and the slider 240 may be configured separately without being coupled to each other, and thus, even if the pusher 230 is located at the first pusher position PP1 and does not press the slider 240, the slider 240 may be provided to be movable between the first slider position SP1 and the second slider position SP2.

The slider 240 may be provided to be movable between the first slider position SP1 adjacent to the pusher 230 and the second slider position SP2 spaced apart from the pusher 230 when the pusher 230 is located at the first pusher position PP1. The slider 240 may move in a direction of becoming away from the pusher 230 as the latch 100 moves from the first latch position LP1 to the second latch position LP2 when the pusher 230 is located at the first pusher position PP1.

For example, when the user grips the handle 32 and applies a force to the door 30 in the direction in which the door 30 is opened, the lock pin 31b may press the door support portion 110 of the latch 100 as illustrated in FIG. 12. When a magnitude of the force applied to the door 30 in the direction in which the door 30 is opened reaches a certain level or higher, the latch 100 located at the first latch position LP1 by the lock pin 31b may rotate in the first rotation direction.

At this time, the slider 240 connected to the latch 100 may move from the first slider position SP1 toward the second slider position SP2 as the latch 100 rotates in the first rotation direction, even though the pusher 230 is in a stopped state. Therefore, the rotation of the latch 100 in the first rotation direction is not restricted by the slider 240, and the latch 100 may smoothly rotate to the second latch position LP2. When the latch 100 reaches the second latch position LP2, the latch 100 may be separated from the door locking part 31, and the door 30 may be opened.

After the door 30 is opened and the latch 100 is completely separated from the door locking part 31, the latch 100 may be returned from the second latch position LP2 to the first latch position LP1 by the restoring force of the elastic spring 102. The slider 240 connected to the latch 100 may be returned from the second slider position SP2 to the first slider position SP1.

As such, as the slider 240 is provided to be separated from the pusher 230, the slider 240 may move with respect to the main body 10 even when the first driving source 220 is damaged or the power is cut off, and thus the user may manually open the door 30 by applying a force of a certain magnitude or greater to the door 30.

In addition, as the slider 240 is provided to be separated from the pusher 230, the slider 240 may move more smoothly with respect to the main body 10, and thus the latch 100 may move more efficiently to that position in a process in which the door 30 is opened or closed.

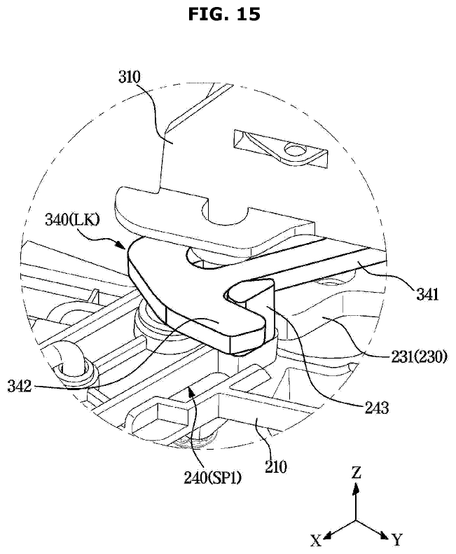

FIG. 14 is a view illustrating a state in which the locker of the latch device of the cooking apparatus is located at a locking position according to an embodiment of the present disclosure. FIG. 15 is a view illustrating the state in which the locker of the latch device of the cooking apparatus is located at the locking position according to an embodiment of the present disclosure.

Referring to FIG. 14 and FIG. 15, the slider 240 of the cooking apparatus 1 according to an embodiment of the present disclosure may be restricted from moving between the first slider position SP1 and the second slider position SP2 when the locker 340 is located at the locking position LK. In other words, the locker 340 may restrict the slider 240 from moving between the first slider position SP1 and the second slider position SP2 when located in the locking position LK. The locker 340 may restrict the latch 100 from moving from the first latch position LP1 to the second latch position LP2 when located in the locking position LK, and thus the door 30, which is closing the cooking chamber 20, may be more firmly secured in a locked state.

As described with reference to FIG. 12, because the slider 240 is movable even when the first driving source 220 does not operate, when the user applies a sufficient force to the door 30, the latch 100 located at the first latch position LP1 rotates and the door 30 may be opened. However, there may be a case where it is appropriate to prevent the user from opening the door 30 arbitrarily. For example, when the heater 26 performs an operation of cooking food inside the cooking chamber 20 by heating the inside of the cooking chamber 20 (hereinafter referred to as a “cooking operation”), when the heater 26 performs an operation of removing residue such as oil attached to the inner walls of the inner case 12 by heating the inside of the cooking chamber 20 to a high temperature above a certain temperature (hereinafter referred to as a “self-cleaning operation”), and in various other cases where the temperature inside the cooking chamber 20 is higher than a certain temperature, it is appropriate for the door 30 to be locked such that the user may not open the door 30 arbitrarily.

Accordingly, the cooking apparatus 1 according to an embodiment of the present disclosure may perform an operation of locking the movement of the latch 100 and slider 240 using the locking module 300 (hereinafter referred to as a “door locking operation”).

When the second driving source 320 operates, the locking cam 330 may rotate in the cam rotation direction around the cam rotation axis 330a. When the locking cam 330 rotates in the cam rotation direction when the locker 340 is located at the unlocking position ULK, the locker 340 may move to the locking position LK.

When the locking cam 330 rotates in the cam rotation direction so that the locker 340 moves from the unlocking position ULK to the locking position LK, the hook portion 342 may move in a direction of becoming close to the cam rotation axis 330a. That is, a distance between the hook portion 342 and the cam rotation axis 330a when the locker 340 is located at the locking position LK may be shorter than a distance between the hook portion 342 and the cam rotation axis 330a when the locker 340 is located at the unlocking position ULK.

The caught portion 243 may be provided to be caught on the hook portion 342 when the slider 240 is located at the first slider position SP1 and the locker 340 is located at the locking position LK. In this case, the hook portion 342 may be located at the direction in which the slider 240 moves from the first slider position SP1 to the second slider position SP2 with respect to the caught portion 243, and thus the hook portion 342 may interfere with the caught portion 243 and restrict the slider 240 from moving to the second slider position SP2.

As an example, when the slider 240 is located at the first slider position SP1 and the locker 340 is located at the locking position LK, the hook portion 342 may come into contact with the caught portion 243 in front of the caught portion 243 to restrict the movement of the slider 240.

As an example, the second slider position SP2 may be located further in front than the first slider position SP1, and the slider 240 located at the first slider position SP1 may move forward toward the second slider position SP2. In this case, the locking position LK may be located further at the rear than the unlocking position ULK. The locker 340 may move rearward from the unlocking position ULK and reach the locking position LK. When the locker 340 is located at the locking position LK, the slider 240 located at the first slider position SP1 may be restricted from moving forward.

As such, as the locker 340 is provided to be movable between the locking position LK and the unlocking position ULK, the locker 340 may restrict or allow the movement of the slider 240. Accordingly, the locker 340 may restrict or allow the movement of the latch 100 and restrict or allow the opening of the door 30.

In order for the locker 340 not to restrict the movement of the slider 240 at the unlocking position ULK, A distance that the locker 340 moves between the locking position LK and the unlocking position ULK may be longer than a distance that the slider 240 moves between the first slider position SP1 and the second slider position SP2. In a case where the distance that the locker 340 moves between the locking position LK and the unlocking position ULK is equal to the distance that the slider 240 moves between the first slider position SP1 and the second slider position SP2, when the locker 340 is located at the unlocking position ULK and the slider 240 is located at the first slider position SP1, the hook portion 342 and the caught portion 243 may come into contact with each other. In a case where the distance that the locker 340 moves between the locking position LK and the unlocking position ULK is longer than the distance that the slider 240 moves between the first slider position SP1 and the second slider position SP2, when the locker 340 is located at the unlocking position ULK and the slider 240 is located at the first slider position SP1, the hook portion 342 and the caught portion 243 may be spaced apart from each other.

The cam position detection sensor 350 may detect the position of the locking cam 330 when the locker 340 is located at the locking position LK using the cam switch 351. In addition, the cam position detection sensor 350 may detect the position of the locking cam 330 while the locker 340 is moving from the unlocking position ULK to the locking position LK using the cam switch 351.

As an example, as illustrated in FIG. 14, when the locker 340 is located at the locking position LK, the locking cam 330 may press the cam switch 351. In detail, when the locker 340 is located at the locking position LK, the second region 332b of the cam surface 332 may face the cam switch 351, and the second region 332b may be formed to press the cam switch 351. Additionally, the cam surface 332 may be provided such that the second region 332b of the cam surface 332 faces the cam switch 351 while the locker 340 is moving from the unlocking position ULK to the locking position LK, and the second region 332b may be formed to press the cam switch 351.

The controller of the cooking apparatus 1, which is electrically connected to the cam position detection sensor 350, may identify the position of the locking cam 330 based on the electrical signal output from the cam position detection sensor 350. The controller of the cooking apparatus 1 may identify that the locker 340 is located at the locking position LK based on the electrical signal output from the cam position detection sensor 350. Alternatively, the controller of the cooking apparatus 1 may identify that the locker 340 is moving from the unlocking position ULK to the locking position LK based on the electrical signal output from the cam position detection sensor 350. The controller of the cooking apparatus 1 may control the second driving source 320 so that the locker 340 may be located at the set position based on the electrical signal output from the cam position detection sensor 350 as described above.

The door locking operation described above may be performed based on a door locking signal being input, which is a user input for locking the door 30.

As an example, the door locking signal may be input through the user interface 60. Components of the user interface 60 capable of receiving the door locking signal may include, but are not limited to, the input button 61 illustrated in FIG. 1 and FIG. 2. The user interface 60 may transmit the inputted door locking signal to the controller of the cooking apparatus 1.

Alternatively, as an example, the cooking apparatus 1 may include a microphone module capable of detecting sound, and the door locking signal may be input through the microphone module. The microphone module may detect various types of sounds that the user is capable of producing using a body thereof, such as a voice of the user. The microphone module may transmit the inputted door locking signal to the controller of the cooking apparatus 1.

Alternatively, as an example, the cooking apparatus 1 may include a motion detection module for detecting detect user motion, and the door locking signal may be input through the motion detection module. The motion detection module may include various types of modules capable of detecting user motion, such as a light sensor like an infrared sensor, a camera module, etc. The motion detection module may transmit the inputted door locking signal to the controller of the cooking apparatus 1.

Alternatively, as an example, the cooking apparatus 1 may include a communication module for performing communication with an external electronic device. The communication module may perform communication with the external electronic device using wired or wireless communication. The external electronic device may include a user terminal such as a smartphone. The external electronic device may include a server device. The external electronic device may transmit the door locking signal to the communication module of the cooking apparatus 1, and the communication module may process the received door locking signal and transmit the processed signal to the controller.

The controller of the cooking apparatus 1 may control the second driving source 320 to locate the locker 340 at the locking position LK based on the door locking signal.

Alternatively, as an example, the controller of the cooking apparatus 1 may receive a user input for executing the self-cleaning operation through the user interface 60, the microphone module, the motion detection module, the communication module, etc. The controller may control the second driving source 320 to locate the locker 340 at the locking position LK to perform the door locking operation based on the user input for executing the self-cleaning operation.

Alternatively, as an example, the cooking apparatus 1 may include a cooking chamber temperature sensor provided to detect the temperature inside the cooking chamber 20. The cooking chamber temperature sensor may be electrically connected to the controller of the cooking apparatus 1. The controller of the cooking apparatus 1 may control the second driving source 320 to locate the locker 340 at the locking position LK to perform the door locking operation based on the temperature inside the cooking chamber 20 being above a preset temperature.

As an example, the door locking operation may be performed under one condition that the door 30 is in the closed state. In detail, the cooking apparatus 1 may include the door opening detection sensor for detecting whether the door 30 is opened. The door opening detection sensor may output the electrical signal corresponding to the opening or closing of the door 30 and transmit the outputted signal to the controller of the cooking apparatus 1. The controller of the cooking apparatus 1 may perform the door locking operation based on the door locking signal being input and the door 30 being closed.

The cooking apparatus 1 may perform a door unlocking operation to unlock the door 30 under a preset condition.

As an example, the controller of the cooking apparatus 1 may receive a user input (hereinafter, a door unlocking signal) for executing the door unlocking operation through the user interface 60, the microphone module, the motion detection module, the communication module, etc. The controller may control the second driving source 320 to locate the locker 340 at the unlocking position ULK based on the door unlocking signal.

As an example, the controller of the cooking apparatus 1 may control the second driving source 320 to locate the locker 340 at the unlocking position ULK to perform the door unlocking operation based on the self-cleaning operation being ended.

As an example, the controller of the cooking apparatus 1 may control the second driving source 320 to locate the locker 340 at the unlocking position ULK to perform the door unlocking operation based on the temperature inside the cooking chamber 20 being below the preset temperature.

As such, the controller receiving and processing a signal for the door locking operation or the door unlocking operation may be composed of the same module as the controller receiving and processing the door opening signal described above or may be composed of a separate module. Additionally, the controller receiving and processing a signal for the door locking operation or the door unlocking operation may be composed of the same module as the controller driving the second driving source 320 or may be composed of a separate module.

In the embodiment described above with reference to FIGS. 1 to 15, the locker 340 of the locking module 300 is disposed above the slider 240 and configured to restrict or allow the movement of the slider 240, but, unlike this, in an embodiment, the locker 340 may be disposed in front of the slider 240 and configured to restrict the movement of the slider 240 by pressing a front end of the slider 240. In this case, the locker 340 may move to the unlocking position ULK by moving forward, and allow the movement of the slider 240.

Unlike what has been described above with reference to FIGS. 1 to 15, in an embodiment, the locker 340 may be configured to interfere with the connecting rod 400 rather than the slider 240 to restrict the movement of the slider 240, connecting rod 400, and latch 100. In this case, the locker 340 may allow the movement of the slider 240, connecting rod 400, and latch 100 by being spaced apart from the connecting rod 400.

Unlike what has been described above with reference to FIGS. 1 to 15, in an embodiment, the connecting rod 400 connecting the latch 100 and the slider 240 may not be provided, and the latch 100 and the slider 240 may be directly connected to each other.

Alternatively, in the embodiment of FIGS. 1 to 15, the slider 240 is configured to transmit the driving force from the pusher 230 to the latch 100, but unlike this, in an embodiment, another structure capable of transmitting the driving force from the pusher 230 to the latch 100 in addition to the slider 240 may be provided, or the pusher 230 may be configured to directly press the latch 100. That is, the latch 100 may have various structures provided such that the latch 100 moves from the first latch position LP1 to the second latch position LP2 when the pusher 230 moves from the first pusher position PP1 to the second pusher position PP2, and the latch 100 is movable between the first latch position LP1 and the second latch position LP2 when the pusher 230 is located at the first pusher position PP1.

In the embodiment of FIGS. 1 to 15, the pusher 230 is configured to rotate around the fixed rotation axis 230a with respect to the main body 10, but is not limited thereto, the pusher 230 may be configured to be separated from the slider 240 and have various structures of being movable to a position of pressing the slider 240 or a position of not pressing the slider 240.

Though the cooking apparatus according to an embodiment of the present disclosure has been described above as an oven, but the present disclosure is not limited thereto and may be applied to various types of cooking apparatus, such as a microwave oven. In addition, the present disclosure may be applied to various types of home appliances and other devices to which a latch device configured to support or release a closed door may be applied.

A cooking apparatus according to an embodiment of the present disclosure may include a main body 10 forming a cooking chamber 20, a door 30 configured to open and close the cooking chamber 20 and including a door locking part 31, a latch 100 disposed in the main body 10 and provided to be movable between a first latch position LP1 of being caught on the door locking part 31 and a second latch position LP2 of being separated from the door locking part 31 when the cooking chamber 20 is closed, a slider 240 connected to the latch 100 and provided to be movable between a first slider position SP1 when the latch 100 is located at the first latch position LP1 and a second slider position SP2 when the latch 100 is located at the second latch position LP2, and a locker 340 disposed in the main body 10 and provided to be movable between a locking position LK of restricting the slider 240 from moving from a first slider position SP1 to a second slider position SP2 and an unlocking position ULK of allowing the slider 240 to move between the first slider position SP1 and the second slider position SP2.

The locker 340 may include a hook portion 342. The slider 240 may include a caught portion 243. The caught portion 243 may be provided to be caught on the hook portion 342 when the slider 240 is located at the first slider position SP1 and the locker 340 is located at the locking position LK. The caught portion 243 may be provided to be spaced apart from the hook portion 342 when the slider 240 is located at the first slider position SP1 and the locker 340 is located at the unlocking position ULK.

The hook portion 342 may be provided to be located in a direction, in which the slider 240 moves from the first slider position SP1 to the second slider position SP2, with respect to the caught portion 243 and to come into contact with the caught portion 243 when the slider 240 is located at the first slider position SP1 and the locker 340 is located at the locking position LK.

The hook portion 342 may be formed at one end of the locker 340 in a direction of moving from the unlocking position ULK to the locking position LK.

The locker 340 may be provided to cover at least a portion of the slider 240 in a direction parallel to a vertical direction Z of the main body 10.

The cooking apparatus may further include a driving source 320 provided to generate a driving force, and a locking cam 330 provided to receive the driving force from the driving source 320 to be rotatable around a cam rotation axis 330a. The locker 340 may be connected to the locking cam 330 and provided to be movable between the locking position LK and the unlocking position ULK when the locking cam 330 rotates.

The locker 340 may be provided such that the locking cam 330 rotates in one direction to move from the unlocking position ULK to the locking position LK, and may be provided such that the locking cam 330 rotates in the one direction to move from the locking position LK to the unlocking position ULK.

The locker 340 may be provided to be rotatable relative to the locking cam 330 around a rotation axis thereof. The rotation axis of the locker 340 may be disposed to be spaced apart from the cam rotation axis 330a.

The locker 340 may include a hook portion 342. The hook portion 342 may be formed to be caught on the slider 240 when the slider 240 is located at the first slider position SP1 and the locker 340 is located at the locking position LK. A distance between the hook portion 342 and the cam rotation axis 330a when the locker 340 is located at the locking position LK may be shorter than a distance between the hook portion 342 and the cam rotation axis 330a when the locker 340 is located at the unlocking position ULK.

The cooking apparatus may further include a cam position detection sensor 350 provided to detect a position of the locking cam 330.

The cam position detection sensor 350 may include a switch 351 provided to generate an electrical signal depending on whether a pressure is applied. The locking cam 330 may include a cam surface 332 formed to press the switch 351 or be spaced apart from the switch 351 as the locking cam 330 rotates.

The cam surface 332 may be provided to be separated from the switch 351 when the locker 340 is located at the unlocking position ULK and to press the switch 351 when the locker 340 is located at the locking position LK.

A distance that the locker 340 moves between the locking position LK and the unlocking position ULK may be longer than a distance that the slider 240 moves between the first slider position SP1 and the second slider position SP2.

The cooking apparatus may further include a locker guide 312 provided to be fixed with respect to the main body 10 and guide the locker 340 such that the locker 340 moves between the locking position LK and the unlocking position ULK.

The cooking apparatus may further include a pusher 230 provided to press the slider 240 from the first slider position SP1 toward the second slider position SP2, a first driving source 220 provided to generate a driving force for the pusher 230 to press the slider 240, and a second driving source 320 provided to generate a driving force for the locker 340 to move between the locking position LK and the unlocking position ULK.

A cooking apparatus according to an embodiment of the present disclosure may include a main body 10 forming a cooking chamber 20, a door 30 configured to open and close the cooking chamber 20 and including a door locking part 31, a latch 100 disposed in the main body 10 and provided to be rotatable with respect to the main body 10 to be caught on the door locking part 31 or separated from the door locking part 31 when the cooking chamber 20 is closed, a slider 240 disposed in the main body 10, connected to the latch 100, and provided to be movable with respect to the main body 10 in conjunction with the rotation of the latch 100, and a locker 340 disposed in the main body 10 and provided to be movable between a locking position LK of fixing the slider 240 and an unlocking position ULK of being spaced apart from the slider 240 to allow the slider 240 to move with respect to the main body 10.

The cooking apparatus may further include a driving source 320 provided to generate a driving force, and a locking cam 330 provided to receive the driving force from the driving source 320 to be rotatable around a cam rotation axis 330a. The locker 340 may be connected to the locking cam 330 and provided to be movable between the locking position LK and the unlocking position ULK when the locking cam 330 rotates.

The locker 340 may include a locker body 341 connected to the locking cam 330, and a hook portion 342 protruding from one side of the locker body 341. The hook portion 342 may be provided to be caught on the slider 240 when the locker 340 is located at the locking position LK. The hook portion 342 may be provided to be spaced apart from the slider 240 when the locker 340 is located at the unlocking position ULK.

The cooking apparatus 1 may further include a cam position detection sensor 350 provided to detect a position of the locking cam 330. The cam position detection sensor 350 may include a switch 351 provided to generate an electrical signal depending on whether a pressure is applied. The locking cam 330 may be formed to press the switch 351 or be spaced apart from the switch 351 as the locking cam 330 rotates.

A cooking apparatus 1 according to an embodiment of the present disclosure may include a main body 10 forming a cooking chamber 20, a door 30 configured to open and close the cooking chamber 20, a latch 100 mounted in the main body 10 and provided to be movable between a first latch position LP1 of supporting the door 30 and a second latch position LP2 of releasing the support of the door to enable the door 30 to be opened when the door 30 closes the cooking chamber 20, a driving source 320 disposed in the main body 10 and provided to generate a driving force, and a locker 340 disposed in the main body 10 and provided to receive the driving force from the driving source 320 to be movable between a locking position LK of restricting the latch 100 from moving from the first latch position LP1 to the second latch position LP2 and an unlocking position ULK of allowing the latch 100 to move between the first latch position LP1 and the second latch position LP2.

According to the present disclosure, a cooking apparatus can provide a structure of automatically opening a door by including a slider connected to a latch and a pusher for pressing the slider.

According to the present disclosure, the cooking apparatus is configured such that the slider is separated from the pusher, so that the slider can be movable with respect to a main body even when a driving module does not operate due to reasons such as damage to the driving source or power cutoff, and thus a user can manually open the door even when the driving module does not operate.

According to the present disclosure, the cooking apparatus includes a locker provided to restrict or allow the movement of the slider, so that the door can be firmly locked when in a locking mode.

According to the present disclosure, the cooking apparatus has a driving module and a locking module arranged adjacent to each other, so that a space occupied by the driving module and the locking module inside the main body can be saved and assembly processes of components can be performed efficiently.

Effects according to the present disclosure are not limited to the effects mentioned above, and other effects not mentioned will be clearly understood by those skilled in the art to which the present disclosure belongs from the fallowing description.

The foregoing has illustrated and described specific embodiments. However, it should be understood by those of skilled in the art that the present disclosure is not limited to the above-described embodiments, and various changes and modifications may be made without departing from the technical idea of the present disclosure described in the following claims.

1. A cooking apparatus comprising:
a main body forming a cooking chamber;
a door, configured to open and close the cooking chamber, including a door locking part;
a latch to be disposed in the main body such that while the latch is in the main body, the latch is movable between a first latch position of being caught on the door locking part and a second latch position of being separated from the door locking part;
a slider connectable to the latch such that while the slider connected to the latch, the slider is movable between a first slider position while the latch is located at the first latch position and a second slider position while the latch is located at the second latch position; and
a locker to be disposed in the main body such that while the locker is in the main body, the locker is movable between a locking position of restricting the slider from moving from the first slider position to the second slider position and an unlocking position of allowing the slider to move between the first slider position and the second slider position.

2. The cooking apparatus according to claim 1, wherein
the locker comprises a hook portion,
the slider comprises a caught portion, and
the caught portion is caught on the hook portion based on the slider being located at the first slider position and the locker being located at the locking position and to be spaced apart from the hook portion based on the slider being located at the first slider position and the locker being located at the unlocking position.

3. The cooking apparatus according to claim 2, wherein
the hook portion is located along a direction, in which the slider moves from the first slider position to the second slider position, with respect to the caught portion and to come into contact with the caught portion based on the slider being located at the first slider position and the locker being located at the locking position.

4. The cooking apparatus according to claim 2, wherein
the hook portion is formed at one end of the locker along a direction in which the locker from the unlocking position to the locking position.

5. The cooking apparatus according to claim 1, wherein
the locker is provided to cover at least a portion of the slider along a direction parallel to a vertical direction of the main body.

6. The cooking apparatus according to claim 1, further comprising:
a driving source to generate a driving force; and
a locking cam to receive the driving force from the driving source and to be rotatable around a cam rotation axis based on the driving force,
wherein the locker is connected to the locking cam and is movable between the locking position and the unlocking position based on the locking cam being rotated.

7. The cooking apparatus according to claim 6, wherein
the locker is provided such that the locking cam rotates along one direction to move from the unlocking position to the locking position and such that the locking cam rotates along the one direction to move from the locking position to the unlocking position.

8. The cooking apparatus according to claim 6, wherein
the locker is provided to be rotatable relative to the locking cam around a rotation axis thereof, and
the rotation axis of the locker is disposed to be spaced apart from the cam rotation axis.

9. The cooking apparatus according to claim 6, wherein
the locker comprises a hook portion,
the hook portion is formed to be caught on the slider based on the slider being located at the first slider position and the locker is located at the locking position, and
a distance between the hook portion and the cam rotation axis while the locker is located at the locking position is shorter than a distance between the hook portion and the cam rotation axis while the locker is located at the unlocking position.

10. The cooking apparatus according to claim 6, further comprising a cam position detection sensor provided to detect a position of the locking cam.

11. The cooking apparatus according to claim 10, wherein
the cam position detection sensor comprises a switch to generate an electrical signal depending on whether a pressure is applied, and
the locking cam comprises a cam surface formed to press the switch or be spaced apart from the switch as the locking cam rotates.

12. The cooking apparatus according to claim 11, wherein
the cam surface is provided to be separated from the switch based on the locker being located at the unlocking position and to press the switch based on the locker being located at the locking position.

13. The cooking apparatus according to claim 1, wherein
a distance that the locker moves between the locking position and the unlocking position is longer than a distance that the slider moves between the first slider position and the second slider position.

14. The cooking apparatus according to claim 1, further comprising
a locker guide provided to be fixed with respect to the main body and guide the locker such that the locker moves between the locking position and the unlocking position.

15. The cooking apparatus according to claim 1, further comprising:
a pusher to press the slider from the first slider position toward the second slider position;
a first driving source to generate a driving force for the pusher to press the slider; and
a second driving source to generate a driving force for the locker to move between the locking position and the unlocking position.
